(19) United States
(12) Patent Application Publication
(10) Pub. No.: US 2008/0298576 A1
(43) Pub. Date: Dec. 4, 2008

(54) Communication system, communication control unit, communication control method. communication control program and monitoring unit

(75) Inventors: Atsushi Tashiro, Kanagawa (JP); Masashi Takada, Kanagawa (JP); Katsuyuki Takahashi, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/081,634

(22) Filed: Apr. 18, 2008

(30) Foreign Application Priority Data
May 28, 2007 (JP) 2007-140867

(51) Int. Cl. H04M 3/00

(52) U.S. Cl. 379/245

(57) ABSTRACT

A communication system 100 connects a plurality of terminals and the communication control unit 101 via a network 110. A group information table 203 of the communication control unit 101 has a that stores identification information of terminal belonging to a group capable of refusing receipts of information transmitted from an originator's terminal relative to identification information of that group and stores identification information of the originator's terminal relative to identification information of the group. A collation judging section 205 judges whether to refuse the receipt from the originator's terminal by collating whether the originator's terminal is registered relative to the group to which the recipient's terminal belongs by using the group information table 203. A communication control section 201 stops or connects the communication between the originator's terminal and the recipient's terminal to refuse or allow the receipt based on the judgment result.

### CROSS-REFERENCE TO RELATED APPLICATION

The present invention contains subject matter related Japanese Patent Application JP2007-140867 filed in the Japan Patent Office on May 28, 2007, the entire contents of which being incorporated herein by reference.

### BACKGROUND OF THE INVENTION

1. Field of the Invention

The present invention relates to a communication system among a plurality of terminals and more specifically to a communication system having a function of enabling a recipient's terminal to refuse received information transmitted from a specific originator's terminal when the recipient does not want to receive the receipt information from that originator's terminal among the plurality of terminals connected to a network.

2. Description of Related Art

With a progress of various communication networks, utilization of such networks has become very active lately. For instance, a system for automatically transmitting phone calls at random or in accordance to a table of predetermined telephone numbers or to a telephone number generating rule has spread in general in certain telephone networks. With such situation, wrong telephone calls caused by mistakes in setting such an automatic call transmitting apparatus are now frequently occurring. In addition, cases when malicious originators intentionally conduct annoying conducts of blocking information from reaching to legitimate recipients or of transmiting information not wanted by recipients to the recipients have come to be seen often.

For example, a system has is proposed that counts a number of times of speeches that stop just by one call, registers an originator's terminal of the speeches as a terminal of annoying telephone calls when that count exceeds a threshold value and informs, when the terminal originates a request for the speech, a user of the recipient's terminal of that the speech is transmitted from the terminal of the annoying phone call.

### SUMMARY OF THE INVENTION

However, although it is possible to refuse the speech that stops by one call as an annoying phone call by the technology described above, it has been unable to deal with such annoying phone calls as persistent solicitation by that technology. In addition, it has been cumbersome for each recipient because it has been necessary to administer telephone numbers of the annoying phone calls by each individual terminal.

In addition, not only the technologies for transmitting and/or receiving voice information using telephones, technologies for transmitting and/or receiving text and image information by e-mail via Internet have spread lately. With that, mails unwanted by recipients have come to be sent frequently from strangers. Incoming frequency of such junk mails is very high because they are automatically sent without intervened by persons like the annoying phone calls and a degree of annoyance is also very high because they are arbitrarily sent semi-permanently from originators as long as the recipient's terminal is registered as a recipient of the originators. Because such junk mails come in while being mixed with important mails, it also takes a lot of time wastefully to discriminate them. A technology for effectively suppressing such unwanted information is being expected from such situation.

In order to address the issues described above, the invention provides a communication system, a communication control unit, a communication control method, a communication control program and a monitoring unit that have functions of refusing information unwanted by the recipient's terminal to come into the recipient's terminal among information transmitted from originator's terminals.

That is, in order to address the above issues, according to one embodiment of the invention, there is provided a communication system in which a plurality of terminals and a communication control unit enable to connect through a network, transmit and/or receive information each other among the plurality of terminals based on a control of the communication control unit, and refuse a receipt of information transmitted from an unwanted terminal.

The communication control unit of the communication system includes a storage section for storing identification information of one or more recipient's terminals that belong to a group capable of refusing the receipt of the information transmitted from an arbitrary originator's terminal among the plurality of terminals relative to identification information of the group, and storing identification information of the originator's terminal relative to the identification information of the group; a collation judging section for judging whether or not the originator's terminal is registered relative to the group to which a specified recipient's terminal belongs by collating the storage section, when either terminal that serves as the originator's terminal among the plurality of terminals requests to transmit information to the specified recipient's terminal; and a communication control section for stopping a connection of communication between the originator's terminal and the specified recipient's terminal to refuse the receipt of the information transmitted from the originator's terminal to the specified recipient's terminal, when the originator's terminal is judged to be registered relative to the group to which the specified recipient's terminal belongs.

According to this configuration, it is judged whether or not the originator's terminal is registered relative to the group to which the specified recipient's terminal belongs by collating the storage section. Then, when the originator's terminal is judged to be registered relative to the group to which the specified recipient's terminal belongs, the information transmitted from the originator's terminal is refused without coming into the specified recipient's terminal.

According to this, the originator's terminal, i.e., an annoying terminal, and the recipient's terminal which does not want the information from the originator's terminal are stored in the storage section by correlating not by one-to-one but with the group, respectively. Thereby, it becomes possible to refuse the incoming information unwanted by the users in unit of group. Because the information on refused terminal may be shared among the terminals belonging to the group by thus performing the process of refusing or allowing incomings in the unit of group, it becomes possible to avoid excessive refusal operations made by the recipient's terminals. In addition, it becomes possible to update the information on the refused terminal instantly when the information of the originator's terminal comes in and to readily refuse the incoming information of the originator's terminal.

In order to address the above issues, according to another embodiment of the invention, there is provided a communication control unit that enable to connect to a plurality of terminals through a network, transmit and/or receive information each other among the plurality of terminals, and refuse a receipt of information transmitted from an unwanted terminal, the communication control unit including: a storage section for storing identification information of one or more recipient's terminals that belong to a group capable of refusing the receipt of the information transmitted from an arbitrary originator's terminal among the plurality of terminals relative to identification information of the group, and storing identification information of the originator's terminal relative to the identification information of the group; and a collation judging section for judging whether or not the originator's terminal is registered relative to the group to which a specified recipient's terminal belongs by collating the storage section, when either terminal that serves as the originator's terminal among the plurality of terminals requests to transmit information to the specified recipient's terminal.

The communication control unit may further include a communication control section for stopping a connection of communication between the originator's terminal and the specified recipient's terminal to refuse the receipt of the information transmitted from the originator's terminal to the specified recipient's terminal, when the originator's terminal is judged to be registered relative to the group to which the specified recipient's terminal belongs.

The communication control section may connect the communication between the originator's terminal and the specified recipient's terminal to transmit the information from the originator's terminal to the specified recipient's terminal, when the collation judging section judges that the originator's terminal is not registered relative to the group to which the specified recipient's terminal belongs.

Thereby, it becomes possible to refuse the speech unwanted by the user in the unit of group. Because the information on refused terminal may be thus shared among the terminals belonging to the group, it becomes possible to avoid excessive refusal operations made by the recipient's terminals. In addition, it becomes possible to update the information on the refused terminal instantly when the information of the originator's terminal comes in and to readily refuse the incoming information of the originator's terminal.

The communication control unit may further include a registering section for registering the identification information of the specified originator's terminal in the storage section relative to the identification information of the group to which the recipient's terminal that requests to refuse the receipt belongs among groups stored in the storage section, when either terminal that serves as the recipient's terminal among the plurality of terminals requests to refuse the receipt of the information transmitted from the unwanted originator's terminal.

The storage section may stores a number of times of retrieval corresponding to the originator's terminal as an accumulated retrieval number relative to the originator's terminal, when the collation judging section retrieves whether or not the originator's terminal is registered in the storage section relative to the group to which the specified recipient's terminal belongs; and the collation judging section judges whether or not to refuse the receipt of the information transmitted from the originator's terminal to the specified recipient's terminal in accordance to the accumulated retrieval number stored in the storage section, when the collation judging section judges that the originator's terminal is registered relative to the group to which the specified recipient's terminal belongs.

Thereby, it becomes possible to judge whether or not the information transmitted from the originator's terminal should be refused from coming into the specified recipient's terminal while considering a degree of refusal of incomings of the originator's terminal based on the accumulated retrieval number indicating the number of times of retrieval to the originator's terminal.

The storage section may stores frequency of refusal or allowance of the receipt among the number of times of retrieval indicated in the accumulated retrieval number stored relative to the originator's terminal; and the collation judging section judges whether or not to refuse the receipt of the information transmitted from the originator's terminal to the specified recipient's terminal based on the frequency of the refusal or the allowance of the receipt among the number of times of retrieval corresponding to the originator's terminal stored in the storage section, when the collation judging section judges that the originator's terminal is registered relative to the group to which the specified recipient's terminal belongs.

Thereby, it becomes possible to adjust whether or not the incoming should be refused by the frequency of allowance or refusal to the present group, to accurately specify the terminal whose incoming should be refused and to effectively refuse the speech unwanted by the user.

The storage section may stores one or more groups to which one or more recipient's terminals belong; and the collation judging section retrieves repeatedly whether or not the originator's terminal is registered respectively relative to one or more groups to which the specified recipient's terminal belongs by a number of the groups to which the specified recipient's terminal belongs, and judge whether or not to refuse the receipt of the information transmitted from the originator's terminal to the specified recipient's terminal based on a result of retrieval.

The communication control unit may include a recovery control section inputs the identification information of the originator's terminal and a control code outputted from the collation judging section, when the inputted control code is an update code requesting to change the content of the storage section, increments frequency of registrations indicating a degree requested to register the originator's terminal identified from the inputted identification information of the originator's terminal as an annoying terminal, and judges whether or not the frequency of registrations meets a predetermined condition; and the collation judging section judge whether or not to refuse the receipt of the information transmitted from the originator's terminal to the specified recipient's terminal based on a result of judgment made by the recovery control section.

Thereby, when the inputted control code is the update code, the actual registration is executed only when the predetermined condition is met like when the frequency of registrations exceeds a predetermined number of times. Thus, it becomes possible to avoid cases when the specific originator's terminal is defined oversensitively as an annoying terminal even though there are not so many requests for registration.

The communication control unit may further include a recovery control section that inputs the identification information of the originator's terminal, a control code and judgment result information indicating a result of judgment made by the collation judging section, when the inputted control code is a collation code requesting to judge whether or not the originator's terminal is an incoming refusing terminal, increments a degree of a refusal receipt of the originator's terminal stored in the storage section relative to the inputted identification information of the originator's terminal corresponding the judgment result information, and judges whether or not the degree of the refusal receipt meets a predetermined condition; and the collation judging section judge whether or not to refuse the receipt of the information transmitted from the originator's terminal to the specified recipient's terminal based on a result of judgment by the recovery control section.

Thereby, the more a count value of information on a number of times of annoying incomings indicating the degree of refusal of incomings of the originator's terminal stored in the storage section increases, the more the information is hardly prone to come again (that is, the incomings are apt to be refused) because the count value of the number of times of annoying incomings is increased only when the inputted control code is the collation code and only when the collation indicates that there exists the registration of annoying phone call. Thereby, even if the annoying phone call registered number is assigned to a new unmalicious line subscriber by reassignment of the telephone number for example, its incoming is allowed as time elapses. That is, it is possible to avoid the shutout of incomings not caused by own responsibility, in addition to that the prevention of incoming annoying information may be realized.

The recovery control section may judge that the frequency of registration meets the predetermined condition, when a value of counter indicating the frequency of registration exceeds a predetermined count number as the predetermined condition.

The recovery control section may judge that the degree of refusal of the receipt meets the predetermined condition, when a value of counter indicating the degree of the refusal receipt exceeds a predetermined count number as the predetermined condition.

The predetermined count number used as the predetermined condition may be represented by an arbitral ratio to a number of recipient's terminals stored relative to the group of the group identification information stored in the storage section.

The recovery control section may decrease a degree of annoyance of the originator's terminal when a period of time becomes longer during which the originator's terminal identified by the identification information of the originator's terminal stored in the storage section does not request to transmit the information to the recipient's terminal belonging to the group stored relative to the originator's terminal, judges whether or not to release the refusal of the receipt of the recipient's terminal belonging to the group stored in the storage section relative to the originator's terminal by judging whether or not the degree of the annoyance of the originator's terminal meets a predetermined first condition.

The recovery control section may judge that the refusal of the receipt of the recipient's terminal that belongs to the group stored relative to the originator's terminal is released, when the counter value indicating the degree of the annoyance of the originator's terminal is equal to or less than the predetermined count number as the first condition.

In addition, the count number set in advance and used as the first condition may be a value represented by an arbitral ratio to a number of recipient's terminals stored relative to the group of the group identification information stored in the storage section.

Thereby, even if the annoying phone call registered number is assigned to a new unmalicious line subscriber by reassignment of the telephone number for example, its incoming is allowed as time elapses. That is, it is possible to avoid the shutout of incomings not caused by own responsibility.

The recovery control section may judge whether or not to erase the registration of the originator's terminal corresponding to the degree of the annoyance stored in the storage section by judging whether or not the degree of the annoyance of the originator's terminal meets a second predetermined condition.

The predetermined count number used as the second condition may be smaller than the predetermined count number used as the first condition.

The communication control section may decide to stop or connect the communication between the originator's terminal and the specified recipient's terminal based on the judgment result information by the recovery control section regardless of the judgment result information by the collation judging section.

When an arbitrary originator's terminal may be registered in the storage section corresponding to a terminal newly requesting the refusal of the receipt of the originator's terminal, if the identification information of the originator's terminal has been already registered relative to identification information of either group, the storage section stores one or more groups of the recipient's terminals stored relative to the identification information of the group that has been already registered in relation to one or more groups of recipient's terminals including the terminal newly requesting the refusal of the receipt of the originator's terminal relative to the identification information of the group already registered.

Thereby, it becomes possible for the recipient's terminal itself to request to form the group in accordance to the instruction of the user of the recipient's terminal. Therefore, it becomes possible to widen a range of terminals sharing the information on the annoying originator's terminal and to form the group in a short time. It also enhances the effect of preventing annoying information. In addition, because the group may be formed automatically, an administrator of the system can considerably save labor required for administrating the group.

It is noted that the communication control unit may have an apparatus for connecting or stopping the communication among the plurality of terminals; and a monitoring unit for monitoring the apparatus, wherein: the apparatus has the communication control section; the monitoring unit has the collation judging section, the registering section and a monitoring control section; and judgment result information judged by the collation judging section is transmitted to the communication control section via the monitoring control section.

In order to address the above issues, according to another embodiment of the invention, there is provided a communication control method that enable to connect to a plurality of terminals through a network, transmit and/or receive information each other among the plurality of terminals based on a control of the communication control unit, and refuse a receipt of information transmitted from an unwanted terminal, the communication control method include steps of: storing identification information of one or more recipient's terminals that belong to a group capable of refusing the receipt of the information transmitted from an arbitrary originator's terminal among the plurality of terminals relative to identification information of the group in a storage section, and storing identification information of the originator's terminal relative to the identification information of the group in the storage section; judging whether or not the originator's terminal is registered relative to the group to which a specified recipient's terminal belongs by collating the storage section, when either terminal that serves as the originator's terminal among the plurality of terminals requests to transmit information to the specified recipient's terminal; and stopping a connection of communication between the originator's terminal and the specified recipient's terminal to refuse the receipt of the information transmitted from the originator's terminal to the specified recipient's terminal, when the originator's terminal is judged to be registered relative to the group to which the specified recipient's terminal belongs.

In order to address the above issues, according to another embodiment of the invention, there is provided A communication control program for executing by computer processes of transmitting and/or receiving information among a plurality of terminals that enable to connect through a network, and processes of refusing a receipt of information transmitted from an unwanted terminal; the communication control program including processes of: storing identification information of one or more recipient's terminals that belong to a group capable of refusing the receipt of the information transmitted from an arbitrary originator's terminal among the plurality of terminals relative to identification information of the group in a storage section, and storing identification information of the originator's terminal relative to the identification information of the group in the storage section; judging whether or not the originator's terminal is registered relative to the group to which a specified recipient's terminal belongs by collating the storage section, when either terminal that serves as the originator's terminal among the plurality of terminals requests to transmit information to the specified recipient's terminal; and stopping a connection of communication between the originator's terminal and the specified recipient's terminal to refuse the receipt of the information transmitted from the originator's terminal to the specified recipient's terminal, when the originator's terminal is judged to be registered relative to the group to which the specified recipient's terminal belongs.

In order to address the above issues, according to another embodiment of the invention, there is provided a monitoring unit for monitoring an apparatus that connects or stops a communication between a plurality of terminals, including: a storage section for storing identification information of one or more recipient's terminals that belong to a group capable of refusing the receipt of the information transmitted from an arbitrary originator's terminal among the plurality of terminals relative to identification information of the group, and storing identification information of the originator's terminal relative to the identification information of the group; a collation judging section for judging whether or not the originator's terminal is registered relative to the group to which a specified recipient's terminal belongs by collating the storage section, when either terminal that serves as the originator's terminal among the plurality of terminals requests to transmit information to the specified recipient's terminal; and a monitoring control section for instructing the apparatus to stop a connection of communication between the originator's terminal and the specified recipient's terminal, when the originator's terminal is judged to be registered relative to the group to which the specified recipient's terminal belongs.

As described above, the invention allows the information unwanted by the recipient's terminal, among the information transmitted from the originator's terminal, to be refused to come into the recipient's terminal.

### BRIEF DESCRIPTION OF THE DRAWINGS

FIG. 1 is an overall structural view of a telephone system according to first through third embodiments of the invention;

FIG. 2 is an internal structural view of a communication control unit of the first and second embodiments;

FIG. 3 shows one exemplary information stored in a group information table 203;

FIG. 4 is a diagram showing one exemplary operation of the communication control unit in each embodiment;

FIG. 5 is a diagram showing one exemplary operation of the communication control unit in the first embodiment;

FIG. 6 is a diagram showing one exemplary operation of the communication control unit in the second embodiment;

FIG. 7 is an internal structural view of the communication control unit of the third embodiment;

FIG. 8 is an internal structural view of a recovery control section of the third embodiment;

FIG. 9 is a diagram showing one exemplary operation of the communication control unit in the third embodiment;

FIG. 10 is a diagram showing one exemplary operation of the communication control unit in the third embodiment;

FIG. 11 is an overall structural view of a telephone system according to a fourth embodiment of the invention;

FIG. 12 is an internal structural view of the communication control unit of the fourth embodiment;

FIG. 13 is a diagram showing one exemplary operation of the communication control unit in the fourth embodiment;

FIG. 14A shows one exemplary configuration of grouping requesting information GR and FIG. 14B shows one exemplary configuration of group updating information GU;

FIG. 15 shows one exemplary information stored in the group information table 203;

FIG. 16A shows one exemplary configuration of the grouping requesting information GR and FIG. 16B shows one exemplary configuration of the group updating information GU;

FIG. 17 shows one exemplary information stored in the group information table; and

FIG. 18 is an overall structural view of a mail communication system according to a modified example of the invention.

### DESCRIPTION OF THE EMBODIMENTS

Embodiments of the invention will be explained below in detail with reference to the appended drawings. It is noted that components having the same structure and function will be denoted by the same reference numerals in the following description and in the appended drawings to omit overlapped explanations thereof. It is also noted that a telephone system will be cited and explained as one exemplary communication system in each embodiment illustrated below.

### First Embodiment

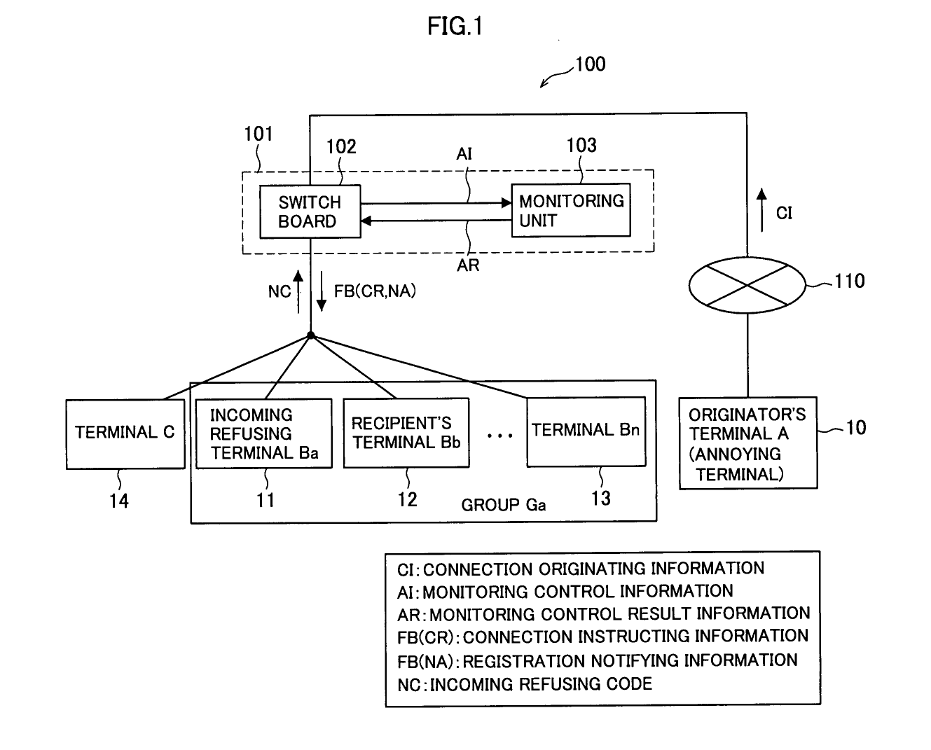

At first, an overall structure of the telephone system using a communication control unit of a first embodiment of the invention will be explained with reference to FIG. 1 showing an outline of the telephone system.

### (Telephone System)

The telephone system 100 includes a communication control unit 101 having a switching unit 102 and a monitoring unit 103 and a plurality of terminals (terminals A 10, Ba 11, Bb 12, . . . Bn 13 and a terminal C 14).

The switching unit 102 receives connection transmitting information CI (e.g., originator's phone number SRC and recipient's phone number NUM) contained in a speech transmitted from the originator's terminal A 10 and outputs monitoring control information AI to the monitoring unit 103. Then, based on monitoring control result information AR outputted out of the monitoring unit 103, the switching unit 102 connects the speech when the speech transmitted from the originator's terminal A 10 is being allowed or stops the speech when the speech is being refused.

The monitoring unit 103 manages the switching unit 102 so that information is transmitted and/or received among the plurality of terminals from each other based on the control made by the switching unit 102 and so as to be able to refuse incoming information transmitted from terminals whose incoming information is unwanted. The communication control unit 101 and the plurality of terminals are connected via a network 110. The plurality of terminals is ordinary telephones for example and exchange voice information among the terminals in the present embodiment.

It is noted that the terminal A 10 is explained as an originator's terminal and the terminals Ba 11, Bb 12, . . . Bn 13 and the terminal C 14 are explained as recipient's terminals in the present embodiment in order to facilitate understanding of the explanation. Specifically, the terminal A 10 is the terminal that transmits information to the terminal Ba 11, the terminal Ba 11 is a terminal that refuses incoming information transmitted from the terminal A 10 and a group Ga represents a group capable of refusing incoming information to the group of terminals belonging to the group Ga.

However, this communication system is not limited to this case and is capable of giving the function of the originator's terminal to the terminal Ba 11 . . . and the terminal C 14 and of giving the function of the recipient's terminal to the terminal A 10. That is, each terminal is capable of functioning as an originator's terminal, a recipient's terminal or a receiving refusing terminal at each time. The group G for refusing the incoming information may also exist as a plurality of groups containing an arbitrary number of terminals of one, two or more. Although one, two or more terminals provided in one office floor or one, two or more terminals belonging to one post provided in the office may be cited as one example of the group for refusing the incoming information, they are not limited to that. For example, preferably the group is set so that one, two or more terminals that are supposed to want to refuse the incoming from the originator's terminal in a similar environment in common belong to the group.

In addition, although the telephone system 100 of the present embodiment will be explained by assuming that the network 110 is a public telephone network, the network is not limited to that and may be the IP network for example.

### (Functional Structure of Communication Control Unit)

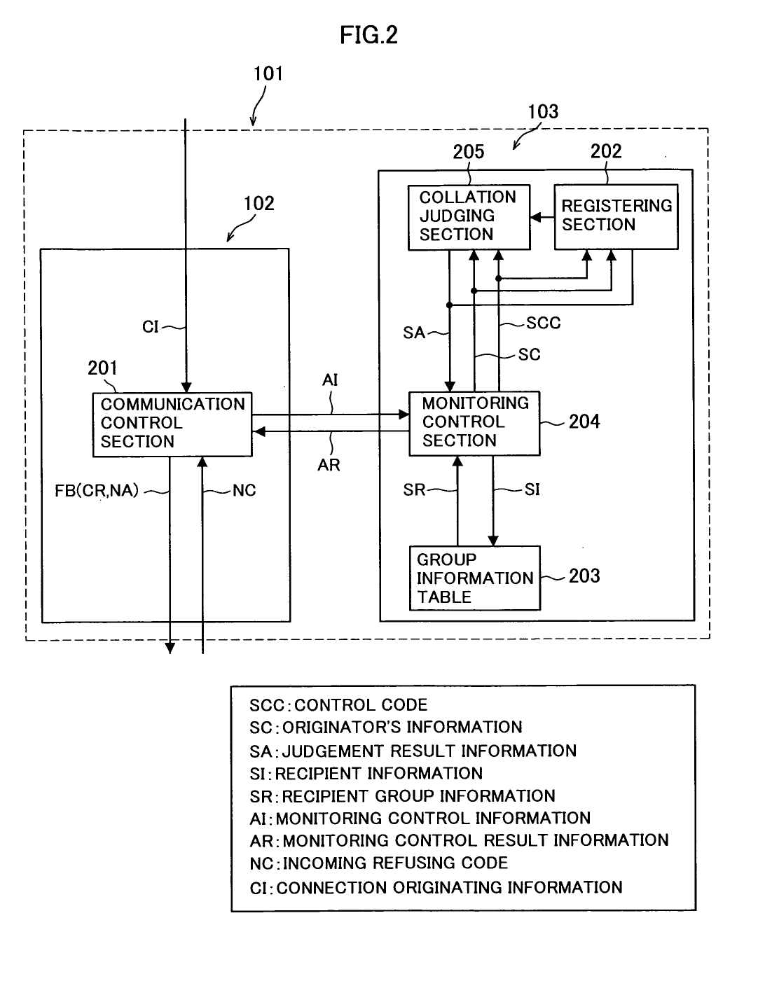

Next, a functional structure of the communication control unit 101 will be explained with reference to FIG. 2. FIG. 2 is a block diagram of the functional structure of the switching unit 102 and the monitoring unit 103 included in the communication control unit 101. The switching unit 102 of the present embodiment has a function denoted by a block of a communication control section 201. In addition, the monitoring unit 103 of the present embodiment has functions denoted by blocks of a monitoring control section 204, a group information table 203, a collation judging section 205 and a registering section 202.

The communication control section 201 in the switching unit 102 receives the connection transmitting information CI received from the network 110 and outputs the monitoring control information AI to the monitoring control section 204. The communication control section 201 also receives a processing result of the monitoring control section 204 as the monitoring control result information AR from the monitoring control section 204 and connects or stops the speech transmitted from the terminal A 10 by outputting connection instructing information FB (CR) from the monitoring control result information. Furthermore, when the communication control section 201 receives an incoming refusing code NC asking for refusal of incoming from the terminal Ba 11 for example, the communication control section 201 outputs it as the monitoring control information AI to the monitoring control section 204 in the same manner as described above, receives the monitoring control result information AR as a processing result of the monitoring control section 204 and outputs registration notifying information FB (NA).

Receiving the monitoring control information AI, the monitoring control section 204 of the monitoring unit 103 outputs a judgment result of a judgment process described later as the monitoring control result information AR based on the monitoring control information AI. The monitoring control section 204 receives the monitoring control information AI from the communication control section 201, obtains recipient's group information SR corresponding to recipient's information SI from the group information table 203 based on that information, outputs the originator information SC and a control code SCC to the collation judging section 205, receives a collation result of the collation judging section 205 as judgment result information SA and outputs the monitoring control result information AR to the communication control section 201.

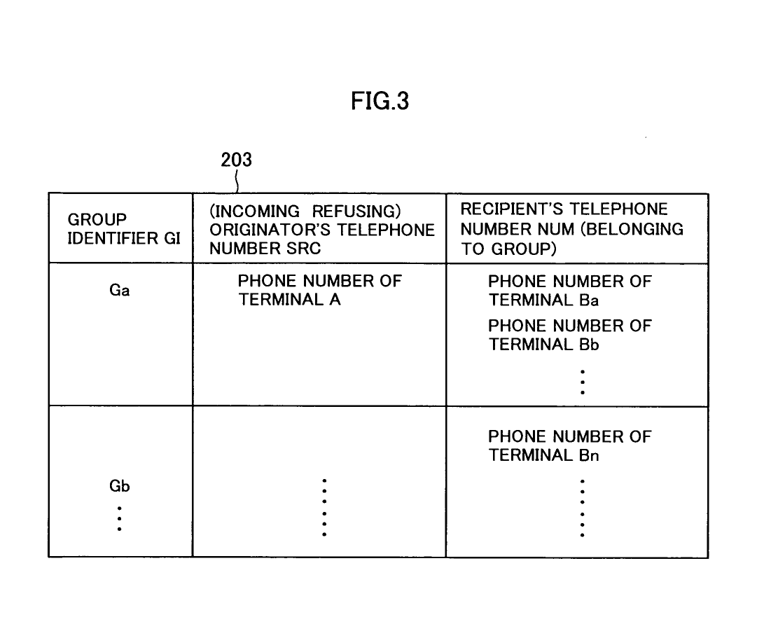

The group information table 203 stores recipient's phone numbers NUM and originator's phone numbers SRC, i.e. subjects of refusal of incoming, in correspondence to group identifiers GI as shown in FIG. 3. The group information table 203 receives the recipient information SI from the monitoring control section 204 and outputs the group identifier GI corresponding to the recipient's phone number NUM that coincides with the recipient information SI as the recipient group information SR. A plurality of group identifiers GI may be set for one terminal and in this case, the judgment process described later is repeated by plural times per each group identifier GI. The monitoring control section 204 outputs the originator information SC to the collation judging section 205 by a necessary number of times and may stop the connection when the judgment result information SA obtained as a result of judgment of the collation judging section 205 contains a result of refusing the incoming.

The collation judging section 205 receives the control code SCC and originator information SC from the monitoring control section 204, carries out collation with information stored in a storage section not shown (simply referred to as the storage section hereinafter) in accordance to the control code SCC for example and outputs the result as the judgment result information SA. The storage section is constructed by including an internal storage area within the collation judging section 205 and the group information table 203. The registering section 202 receives the control code SCC and the originator information SC from the monitoring control section 204, carries out registration (update) of the information stored in the storage section in accordance to the control code SCC and outputs its result as the judgment result information SA. Thus, the monitoring unit 103 functions so as to enable the terminals to refuse an incoming from either one of terminals in the telephone system 100 of the present embodiment.

Next, operations in the telephone system 100 will be explained. In the present embodiment, the operations of the telephone system 100 will be explained by exemplifying cases when the terminal A 10 originates a call to the terminal Bb 12 and when the terminal Ba 11 is registered as a terminal refusing the terminal A 10 as shown in FIG. 1. (When the originator's terminal A 10 requests a speech to the recipient's terminal Bb 12: Collation Judging Process)

When the terminal A 10 originates a call to the terminal Bb 12, the terminal A 10 outputs the connection transmitting information CI containing the recipient's phone number NUM of the terminal Bb 12 at first. Receiving the connection transmitting information CI, the switching unit 102 outputs the information to the monitoring unit 103 as the monitoring control information AI. The monitoring unit 103 performs a judgment process described later therein and outputs its result to the switching unit 102 as the monitoring control result information AR.

When the originator's terminal of the speech is what is to be refused from the result of the monitoring control result information AR, the switching unit 102 stops the speech or otherwise outputs a signal FB (connection instructing information CR) and connects the speech. When the switching unit 102 stops the speech, the switching unit 102 may be transmit a message to the effect that it is unable to connect to the terminal Bb 12.

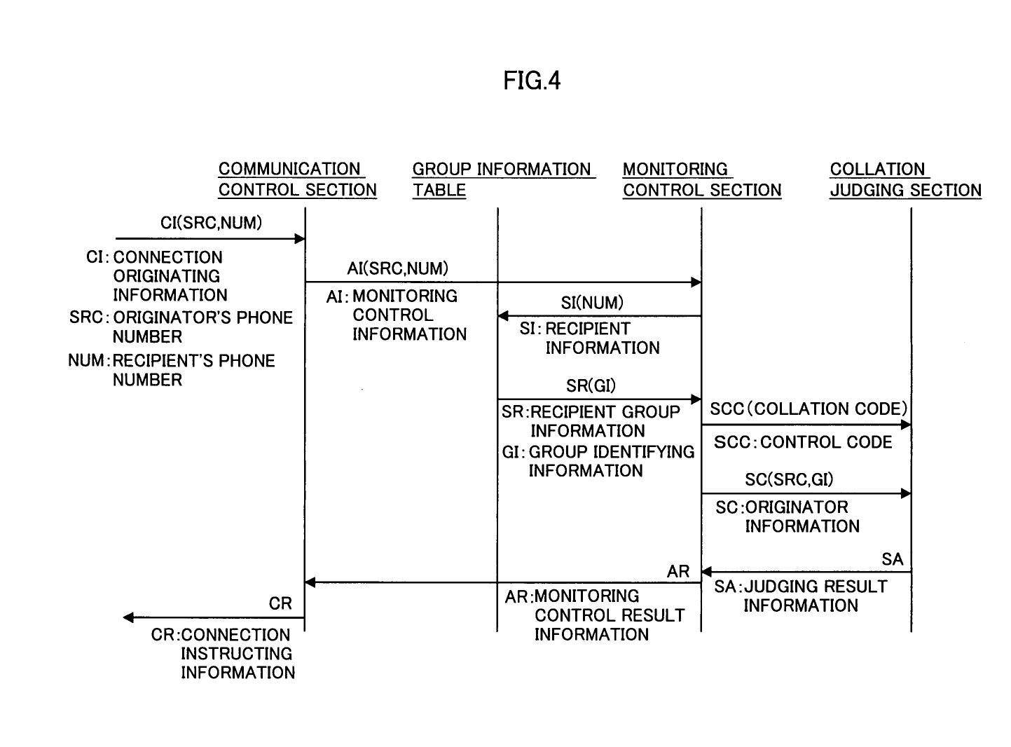

Next, an internal process and the judgment process performed in the switching unit 102 and the monitoring unit 103 will be explained by using FIG. 4. The communication control section 201 within the switching unit 102 receives the connection transmitting information CI from the originator's terminal A 10. The connection transmitting information CI contains the recipient's phone number NUM and the originator's phone number SRC. The communication control section 201 outputs the information on the two phone numbers to the monitoring control section 204 of the monitoring unit 103 as the monitoring control information AI.

Obtaining the monitoring control information AI, the monitoring control section 204 inquires the recipient's phone number NUM contained in the monitoring control information AI to the group information table 203 as the recipient information SI and obtains the group identifier GI to which the recipient's phone number NUM belongs as the recipient group information SR. While the group information table 203 stores that to which group the terminal corresponding to the recipient's phone number NUM belongs, the correspondence between the recipient's phone number NUM and the group identifier GI may be registered in the group information table 203 in advance.

The monitoring control section 204 outputs the control code SCC and the originator information SC to the collation judging section 205. Here, a code meaning collation (collation code) is given to the control code SCC. The originator information SC contains the group identifier GI contained in the recipient group information SR obtained by the monitoring control section 204 and the originator's phone number SRC contained in the monitoring control information AI.

When the control code SCC is the collation code, the collation judging section 205 retrieves the originator's phone number SRC set in the group identifier GI from corresponding data of the group identifier GI and the originator's phone number SRC. While the collation judging section 205 retrieves the originator's phone number SRC set in the group identifier GI from data stored in the storage area within the collation judging section 205 for example in the present embodiment, the corresponding data of the group identifier GI and the originator's phone number SRC may be stored in the group information table 203 as shown in FIG. 3. It is noted that the storage area within the collation judging section 205 and the group information table 203 are one exemplary storage section as described before.

When the originator's phone number SRC corresponding to the group identifier GI is found as a result of the retrieval, the collation judging section 205 outputs information indicative of that the connection is not allowed to the monitoring control section 204 as the judgment result information SA.

When the originator's phone number SRC corresponding to the group identifier GI is not found as a result of the retrieval in contrary, the collation judging section 205 outputs information indicative of allowing the connection to the monitoring control section 204 as the judgment result information SA. The monitoring control section 204 outputs the judgment result judgment result information SA) in the collation judging section 205 to the communication control section 201 as the monitoring control result information AR.

It is noted that although the judgment result information SA has a flag of “1” when the connection is allowed and of “0” when the connection is not allowed, other information may be used as long as it is possible to discriminate whether or not the connection is allowed. For example, it may be arranged so as to output the recipient's phone number NUM when the connection is allowed and “0” when the connection is disallowed. It is also desirable to store an accumulated number of retrieval in the originator's phone number SRC set in the group identifier GI at this time. That is, the collation judging section 205 may increment the corresponding accumulated retrieval number by one when the originator's phone number SRC is found by the retrieval. Based on the number of retrieval (accumulated retrieval number) thus accumulated, the collation judging section 205 may judge so as to refuse the incoming to the recipient's terminal requested to have the speech from the originator's terminal when the accumulated retrieval number is larger than a predetermined threshold value for example.

It is also possible to change the connection allowable status corresponding to a number of times of inquiry, not by the judgment by the accumulated retrieval number performed by the collation judging section 205. For example, it is possible to arrange so that the connection is allowed with a proportion of an inverse number of the number of times of inquiry when it is judged to be possible to connect. However, the proportion is not limited to the inverse number of the number of times of inquiry as long as a judging method in which a number of times of connection decreases corresponding to an increase of the number of times of inquiry is adopted.

When the monitoring control result information AR is indicative of that the connection is allowed, the communication control section 201 outputs the connection instructing information CR to connect the speech to the terminal Bb 12 or stops the connection when the connection is disallowed. The terminal Bb 12 connects the incoming of the terminal A 10 to allow the speech only when the speech is allowed by the connection instructing information CR. Or, in the process when the connection is disallowed, the communication control section 201 may connect the speech of the terminal A 10 to a terminal not shown that outputs a message to the effect that the connection cannot be made, without stopping the connection. In this case, it is also possible to set a phone number of that terminal as the judgment result information SA.

Thus, it becomes possible to determine and control whether or not the terminal A 10 should be connected to the terminal Bb 12 by judging whether or not the incoming of the speech transmitted from the terminal A 10 should be refused by the collation judging section 205 from the originator's phone number SRC and the group identifier GI. (When the recipient's terminal Ba 11 does not want the incoming from the originator's terminal A 10: Updating Process)

Next, the operations of the telephone system 100 performed when the recipient's terminal Ba 11 registers the originator's terminal A 10 as a terminal to be refused, i.e., when the terminal Ba 11 does not want any incoming from the terminal A 10, will be explained by using FIG. 1 again.

When a user using the terminal Ba 11 does not want any incoming from the terminal A 10, the terminal Ba 11 outputs an incoming refusing code NC to the switching unit 102 by a method set in advance. The incoming refusing code NC may be what a number set by the user in advance is inputted to the terminal Ba 11. However, the method for outputting the incoming refusing code NC is not limited to that and may be arranged so as to output the incoming refusing code NC by calling a phone number set in advance immediately after disconnecting the speech. The incoming refusing code NC contains the phone number (recipient's phone number) NUM of the terminal Ba 11 and a code N (e.g., a phone number set in advance) indicative of refusing the incoming.

The switching unit 102 receives the incoming refusing code NC from the terminal Ba 11 and outputs the phone number (recipient's phone number) NUM and the code N indicative of refusing the incoming from the incoming refusing code NC to the monitoring unit 103 as the monitoring control information AI. The monitoring unit 103 carries out a registering process described later therein and outputs its result to the switching unit 102 as the monitoring control result information AR.

The switching unit 102 outputs the result of the monitoring control result information AR to the terminal Ba 11 as a signal FB (registration notifying information NA). The terminal Ba 11 receives the signal FB (registration notifying information NA) and a display not shown of the terminal Ba 11 displays that a setting for refusing the incoming of the terminal A 10 has been completed by text information for example.

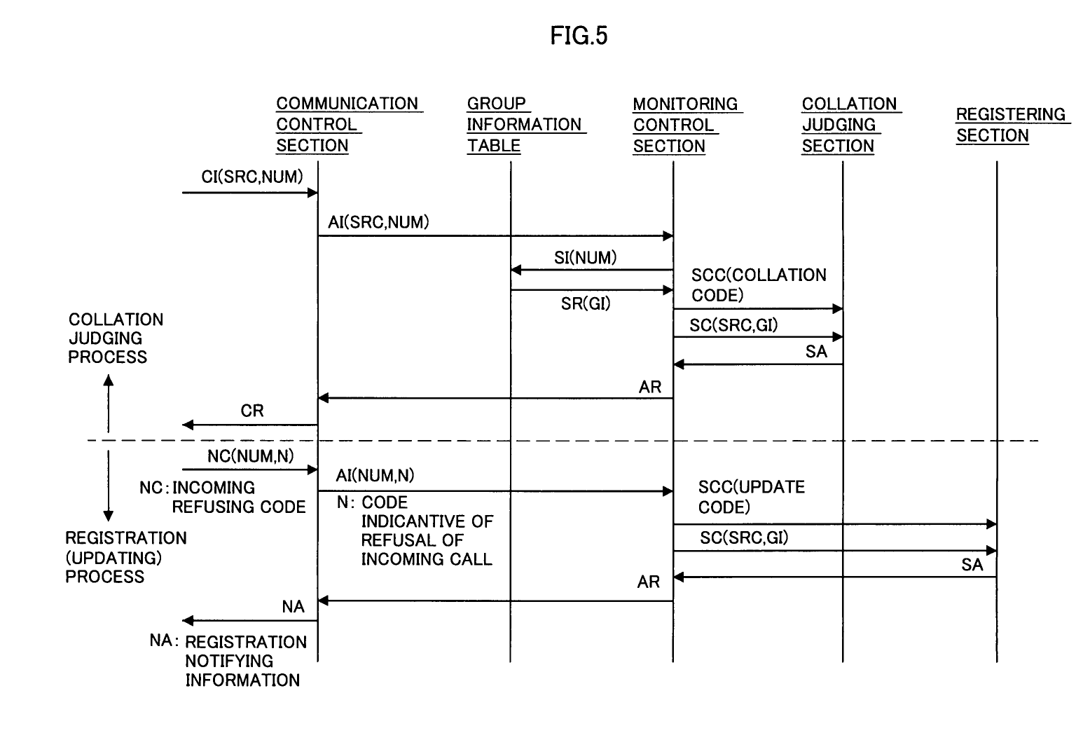

The internal process and the registering (updating) process carried out in the switching unit 102 and the monitoring unit 103 will be explained by using FIG. 5. Because this registering process occurs after carrying out the collation judging process explained by using FIG. 4, the following explanation will be made supposing that the collation judging process has been already carried out.

Receiving the incoming refusing code NC, the communication control section 201 outputs it to the monitoring control section 204 as the monitoring control information AI. When a recipient destination of the monitoring control information AI thus obtained is the code N indicative of that an incoming is refused, the monitoring control section 204 judges that the monitoring control information AI is to be registered (updated) to the storage section and outputs the originator information SC containing the information of the control code SCC indicating the code (update code) meaning updating, the originator's phone number SRC and the group identifier GI obtained during the judgment process to the registering section 202.

When the control code SCC is the update code, the registering section 202 stores the originator's phone number SRC to the storage section (e.g., the internal storage area within the collation judging section 205) relative to the group identifier GI contained in the originator information SC. At this time, an accumulate retrieval number correlating with the originator's phone number SRC is set. When the storage is completed, the registering section 202 outputs a processing result to the monitoring control section 204 as judgment result information SA. The judgment result information SA may be a code that is 1 when the update is successful and is 0 when the update is unsuccessful. Receiving the judgment result information SA, the monitoring control section 204 outputs the judgment result information SA as the monitoring control result information AR. The monitoring control result information AR may be information similar to the judgment result information SA.

After obtaining the monitoring control result information AR, the communication control section 201 outputs the registration notifying information NA to notify the terminal Ba 11 of the registration status to the registering section 202 contained in the monitoring control result information AR.

It becomes possible to refuse the incoming of the originator's terminal A 10 not only to the terminal Ba 11 but also to the other recipient's terminals Bb 12, . . . and Bn 13 belonging to the group identified by the group identifier GI by thus registering the correspondence of the originator's phone number SRC and the group identifier GI to the speech transmitted from the originator's terminal A 10 by the registering section 202.

According to the present embodiment, it becomes possible to refuse the speech unwanted by the user in the unit of group by providing both the switching unit 102 and the monitoring unit 103. It is also possible to avoid excessive refusing operations to be carried out because the information of the incoming refusing terminal may be shared by performing the processes by the group. In addition, it becomes possible to immediately update the refusing terminal information when the speech comes in and to easily refuse the speech.

### Second Embodiment

Next, the telephone system 100 of a second embodiment will be explained. In the second embodiment, operations of the communication control section 201 within the switching unit 102 and the monitoring control section 204, the collation judging section 205 and the registering section 202 within the monitoring unit 103 are different from those of the first embodiment. In addition, a method of the judgment process for the speech from the terminal A 10 and operations when the speech is allowed after the judgment process are different from those of the first embodiment in the second embodiment. Furthermore, the collation judging section 205 of the second embodiment is different from the first embodiment in that the connection enabling status is changed corresponding to a number of times of inquiry. Accordingly, the telephone system 100 of the present embodiment will be explained centering on those differences.

The overall structure and functional structure of the second embodiment are the same with those of the first embodiment as shown in FIGS. 1 and 2. What are different from the first embodiment are the method of the process for judging the speech from the terminal A 10 and that processes (allowance registering process) for confirming that a speech between the terminal A 10 and the terminal Ba 11 is completed and for storing that the speech has been what the recipient wanted to the monitoring unit 103 are implemented.

In implementing the process for judging the speech from the terminal A 10, the collation judging section 205 retrieves the originator's phone number SRC correlated with the group identifier GI contained in the received originator information SC, implements the judgment process by using the stored accumulated retrieval number and an accumulated allowance registering number described later and outputs the judgment result as the judgment result information SA. This judgment process will be described later.

At the time when the speech between the terminal A 10 and the terminal Ba 11 is completed, the switching unit 102 outputs information indicating that the speech has been normally finished (normal finish information) as the monitoring control information AI when no incoming refusing code NC is transmitted even when the speech between the terminal A 10 and the terminal Ba 11 is finished. That the speech has been finished normally in this case means that the speech was not a speech unwanted by the terminal Ba 11. The monitoring control information AI will do if it contains the normal finish information and may be information setting a flag indicative of the normal finish information or information in which numbers of the originator and the recipient are both zero (initial value). The monitoring unit 103 receives the monitoring control information AI from the switching unit 102 and performs a normal finishing process described later within the monitoring unit 103 if the monitoring control information AI contains the normal finish information.

That is, the communication control section 201 of the switching unit 102 outputs the monitoring control information AI to the monitoring control section 204 when the speech between the terminal A 10 and the terminal Ba 11 ends. The monitoring control section 204 in the monitoring unit 103 receives the monitoring control information AI and when the monitoring control information AI contains the normal finish information, outputs the originator information SC containing the control code SCC containing a code (allowance update code) indicating registration of a non-refusing terminal, the originator's phone number SRC during the speech and the group identifier GI to which the terminal Ba 11 belongs to the registering section 202 and receives a registration result in the registering section 202 as judgment result information SA.

The registering section 202 receives the control code SCC and the originator information SC from the monitoring control section 204, implements registration to the information stored in the storage section in accordance to the control code SCC and outputs the implementation result as the judgment result information SA. As a result, the group identifier GI corresponding to the originator's phone number SRC, the accumulated retrieval number and the accumulated allowance registering number are stored in the group information table 203. It is noted that the group identifier GI corresponding to the originator's phone number SRC, the accumulated retrieval number and the accumulated allowance registering number may be stored within the collation judging section 205.

### (Method of Judgment Process)

Next, the operations of the second embodiment will be explained. The present embodiment is different from the first embodiment in that the method of the judgment process is different and in that the allowance registering process is newly added, so that those points will be explained, respectively.

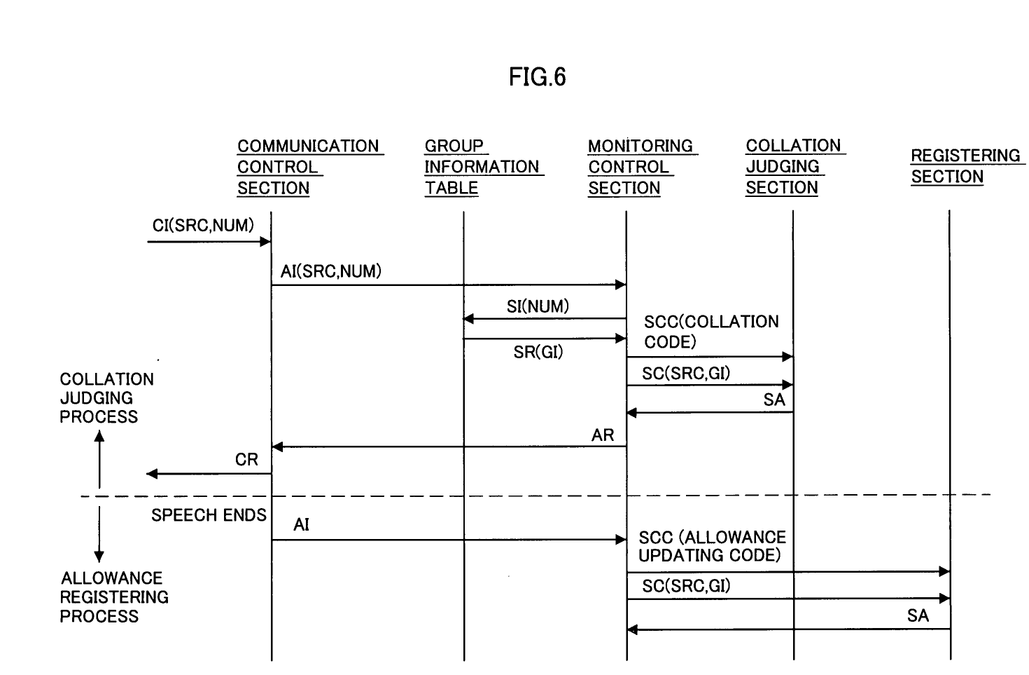

At first, the method of the judgment process will be explained with reference to FIG. 6. The collation judging section 205 retrieves the storage section (e.g., the group information table 203 and the storage area within the collation judging section 205) to find the originator's phone number SRC corresponding to the connection transmitting information CI contained in the received originator's information SC. When no originator's phone number SRC is found as a result of the retrieval, the collation judging section 205 outputs a flag allowing the connection as the judgment result information SA in the same manner with the first embodiment.

When the originator's phone number SRC is found in contrary, the collation judging section 205 sets a difference between the stored accumulated retrieval number and an accumulated allowance registration number stored by a method described later as a reduced accumulated retrieval number and implements the judgment process by using the reduced accumulated retrieval number in the same manner with the accumulated retrieval number of the first embodiment. The actual method of the judgment process will do as long as it is the same with the judgment process of the accumulated retrieval number in the first embodiment. The method for deciding the reduced accumulated retrieval number is not limited to this method and the reduced accumulated retrieval number may be decided by similarly obtaining a difference after adding a weight of 0.5 to the accumulated allowance registration number for example. It is noted that the accumulated allowance registration number and the reduced accumulated retrieval number are one example indicating frequency when the incomings are refused or allowed.

Next, the allowance registering process will be explained by using FIG. 6. The communication control section 201 confirms that no incoming refusing code NC is transmitted from the terminal Ba 11 after the end of the speech between the terminal A 10 and the terminal Ba 11 and outputs the monitoring control information AI to the monitoring control section 204 when there is no incoming refusing code NC. The judgment that the speech has been finished normally may be made when no incoming refusing code NC is transmitted within a certain period of time (e.g., 45 seconds) after the disconnection of the speech made by the terminal Ba 11 for example. However, the method for judging that the speech has finished normally is not limited to the method of using the fixed time and may be a method of using variable time set corresponding to a number of times of inquiry for example. The monitoring control information AI will do as long as it contains the normal finish information and the flag indicative of the normal finish information may be set or the information indicating that the numbers of the originator and recipient are both 0 may be set as described above.

The monitoring control section 204 receives the monitoring control information AI and confirms whether or not the signal contains the normal finish information. When the signal contains the normal finish information, the monitoring control section 204 outputs the originator's phone number SRC of the terminal A 10 and the group identifier GI of the terminal Ba 11 obtained in the judgment process as originator information SC as well as the allowance update code as the control code SCC. In case when the normal finish information notifies only that the speech has been finished here, the monitoring control information AI may be judged to be a signal containing the normal finish information when the monitoring control section 204 does not receive any monitoring control information containing the code N indicating that an incoming is refused by receiving the incoming refusing code NC during a predetermined time (e.g., 60 seconds).

When the originator information SC is the allowance update code, the registering section 202 retrieves the originator's phone number SRC corresponding to the group identifier GI and increments the accumulated allowance registration number by one when the originator's phone number is found.

Although no registration result of the registering section 202 is outputted in the allowance registration process in the present embodiment, it may be also arranged so as to notify of the registration result to the terminal Ba 11 and to display the registration result in the terminal Ba 11 by using the judgment result information SA, the monitoring control result information AR and the registration notifying information NA. In this case, it is also possible to judge that the speech has been normally finished by arranging such that the terminal Ba 11 transmits a request for allowance registration not shown to the communication control section 201 in the same manner with the refusal registration process of the first embodiment. It is possible to expect the same effect with those described above by this method.

According to the present embodiment, it becomes possible to adjust whether or not an incoming should be refused by the frequency of allowance and the frequency of refusal to the present group and to more accurately specify the terminal whose incoming should be refused by holding the accumulated allowance registration number in the group information table 203, rather than judging the terminal to be refused only by the accumulated retrieval number like the first embodiment. In addition, because the effect of the first embodiment may be also brought about by the present embodiment, it becomes possible to more effectively refuse the speech unwanted by the users.

### Third Embodiment

Next, the telephone system 100 of a third embodiment will be explained below centering on differences thereof from the first and second embodiments. Although the functions and other structures of the collation judging section 205 explained in the first embodiment are applied in the present embodiment, the functions and other structures of the collation judging section 205 disclosed in the second embodiment may be also applied.

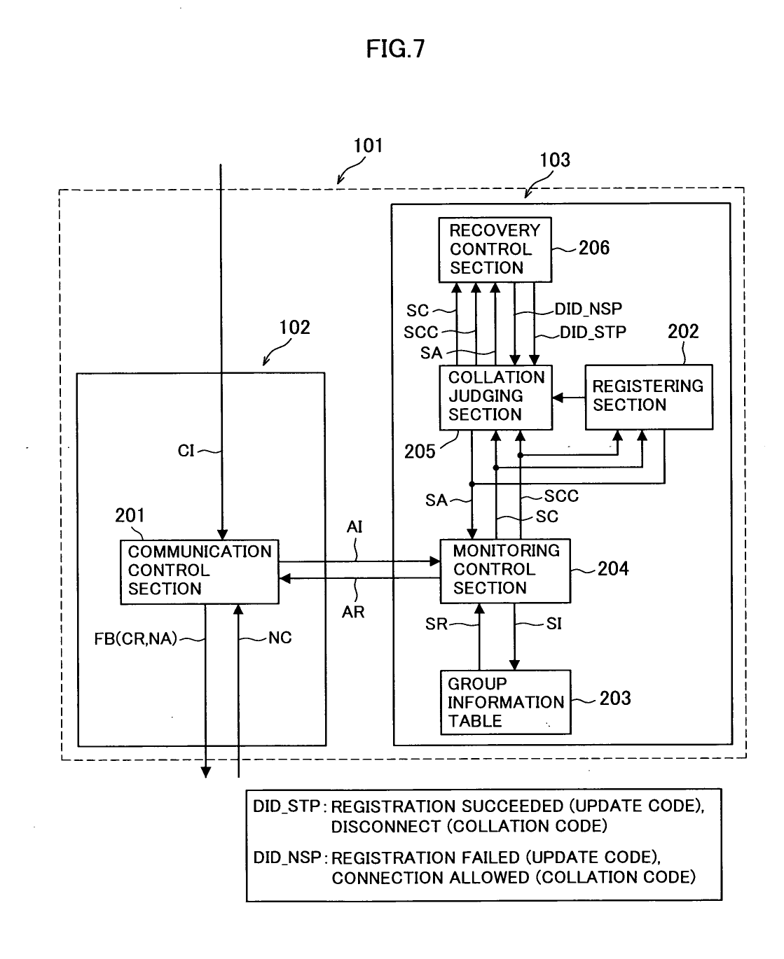

As FIG. 7 shows a functional structure of the communication-control unit 101 of the third embodiment, the monitoring unit 103 of the present embodiment is different from those in the first and second embodiment in that a recovery control section 206 is newly provided and has the same function with the monitoring unit 103 of the first embodiment other than that.

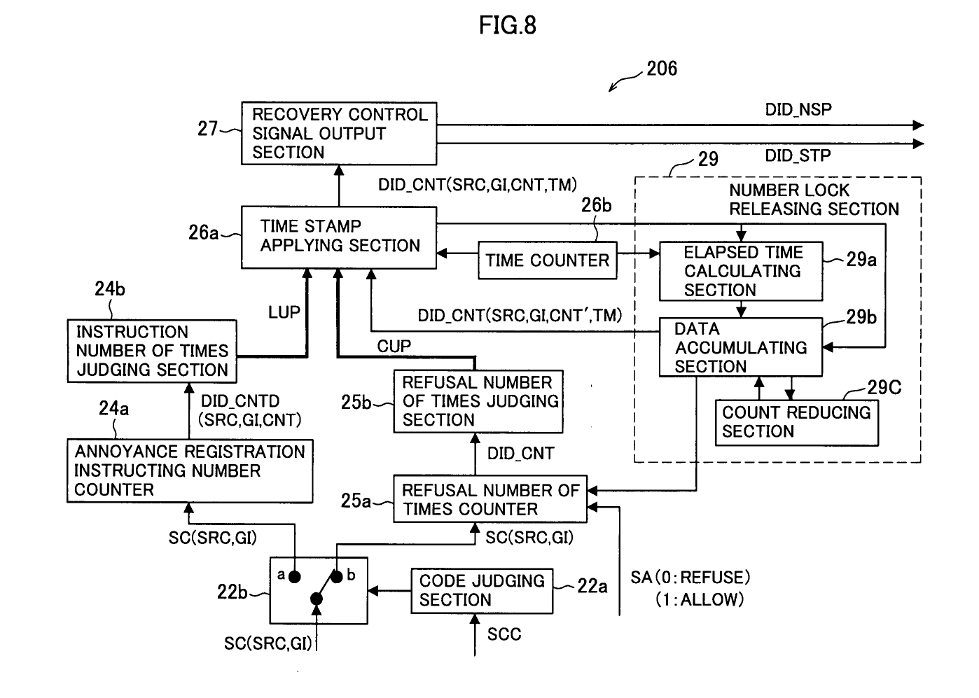

Then, an internal structure of the recovery control section 206 newly provided in the present embodiment will be explained with reference to FIG. 8. The recovery control section 206 has a code judging section 22a, a switch 22b, an annoyance registration instructing number counter 24a, an instruction number of times judging section 24b, a refusal number of times counter 25a, a refusal number of times judging section 25b, a time stamp applying section 26a, a time counter 26b, a recovery control signal output section 27 and a number lock releasing section 29. The number lock releasing section 29 further includes an elapsed time calculating section 29a, a data storage section 29b and a count decrementing section 29c.

The switch 22b has terminals a and b. The terminal a of the switch 22b is connected to the annoyance registration instructing number counter 24a and the terminal b of the switch 22b is connected to the refusal number of times counter 25a. Further, the respective sections shown in the respective blocks are connected from each other so that signals are sent in directions of arrows in FIG. 8. Specifically, a signal line between the time stamp applying section 26a and the refusal number of times judging section 25b is thick to represent that there are cases of transmitting only an input signal and of transmitting a plurality of signals including a judgment result signal described later, i.e., to represent that there are two signal lines. The same applies to a thick line between the time stamp applying section 26a and the instruction number of times judging section 24b.

As for the telephone system 100 of the present embodiment in FIGS. 7 through 10, operations of the whole system will be explained centering on the operation of the recovery control section 206 that is different from the first embodiment with reference to FIGS. 7, 9 and 10 and then the operation of the recovery control section 206 will be explained with reference to FIG. 8. The points other than that are the same with those in the first embodiment, so that they will not be explained here.

Differing from the first embodiment, the collation judging section 205 of the present embodiment once outputs the originator information SC, the control code SCC and the judgment result information SA to the recovery control section 206. Then, the collation judging section 205 outputs judgment result information SA to the monitoring control section 204 corresponding to an output from the recovery control section 206. The other functions are the same with those of the first embodiment.

The control code SCC may be an update code for registering an annoying phone list or a collation code for collating whether or not a phone call is made from an annoying telephone number as explained in the first embodiment. The judgment result information SA may be also a signal indicating success and/or failure of registration when the control code SCC is set as the update code or may be a signal indicating whether or not a connection is enabled and/or disabled when the control code SCC is set as the collation code.

In the third embodiment, the collation judging section 205 once outputs the originator information SC, the control code SCC and the judgment result information SA to the recovery control section 206 before returning a response to the monitoring control section 204 and outputs the judgment result information SA to the monitoring control section 204 corresponding to the outputs of the recovery control section 206 to the respective codes described above.

States how each section indicated by each block operates by the respective codes in the third embodiment will be explained below in detail. It is noted that in view of a state in which the third embodiment is actually operated, a state how the annoying phone call is registered will be explained first and then a state how the registered annoying phone call is prevented will be explained.

### (Update Process)

Similarly to the first embodiment, there is no information of an originator defined to be an annoying phone call in an initial state of the communication control unit 101 also in the present embodiment. A designer of the system may set such information in the storage area of the collation judging section 205 and the recovery control section 206 or in the storage section beforehand in operating the system as a matter of course. The operation performed at that time is the same with an operation of a “collation code” described later, so that it will not be explained here.

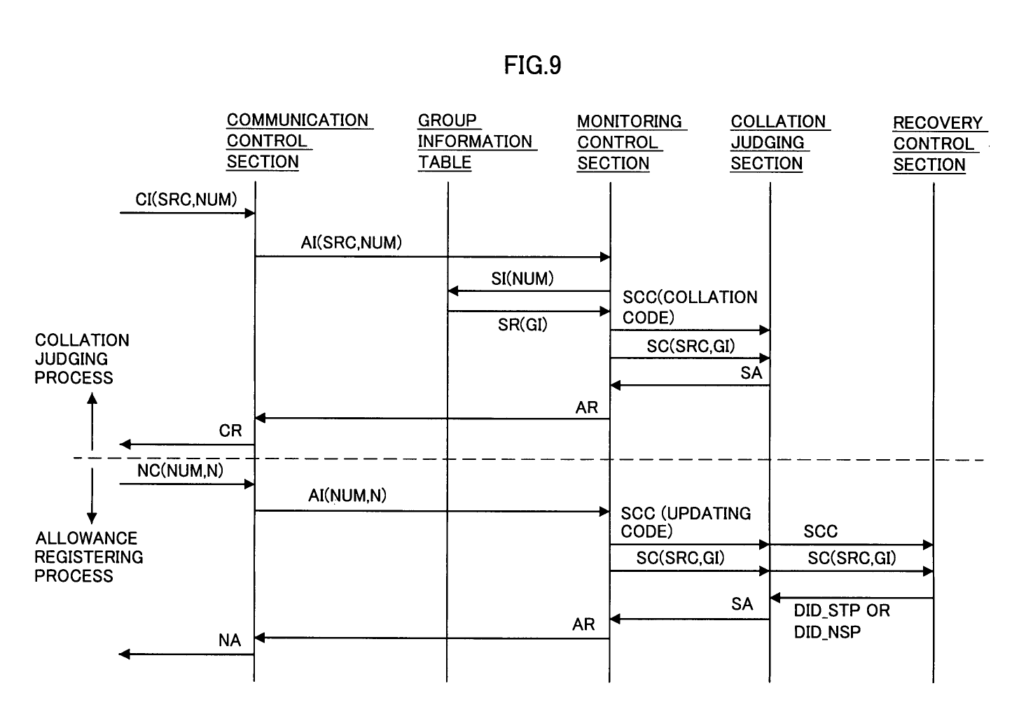

By the way, the users of the terminals Ba 11 through Bn 13 who received the annoying phone call carry out the similar operations with the first embodiment in order to register the originator's terminal of the phone call as an annoying phone call list in the same manner with the first embodiment. The operation by this update code will be explained by using FIG. 9. Then, similarly to the case of the first embodiment, the originator information SC and the control code SCC are inputted to the collation judging section 205.

When the control code SCC is the “updating code”, the control code SCC is a signal representing “updating instruction”. The originator information SC is a signal actually containing a plurality of contents and specifically contains the originator's phone number SRC and the group identifier GI. When the control code SCC is the “updating code”, the recovery control section 206 outputs a signal DID_STP when the registration is successful and a signal DID_NSP when the registration is unsuccessful to the collation judging section 205. The recovery control section 206 outputs only either one of the signals DID_STP and DID_NSP and does not output them simultaneously.

The collation judging section 205 outputs a signal indicating that “registration has been successful” as the judgment result information SA in the same manner with the first embodiment when the recovery control section 206 outputs DID_STP and outputs a signal indicating that “registration has been unsuccessful” as the judgment result information SA when the recovery control section 206 outputs DID_NSP. The operation of each section shown by each block thereafter is the same with that of the first embodiment, so that their explanation will be omitted here. Thus, the registration or update of the terminal (originator's terminal) specified as the annoying telephone is completed.

### (Collation Judging Process)

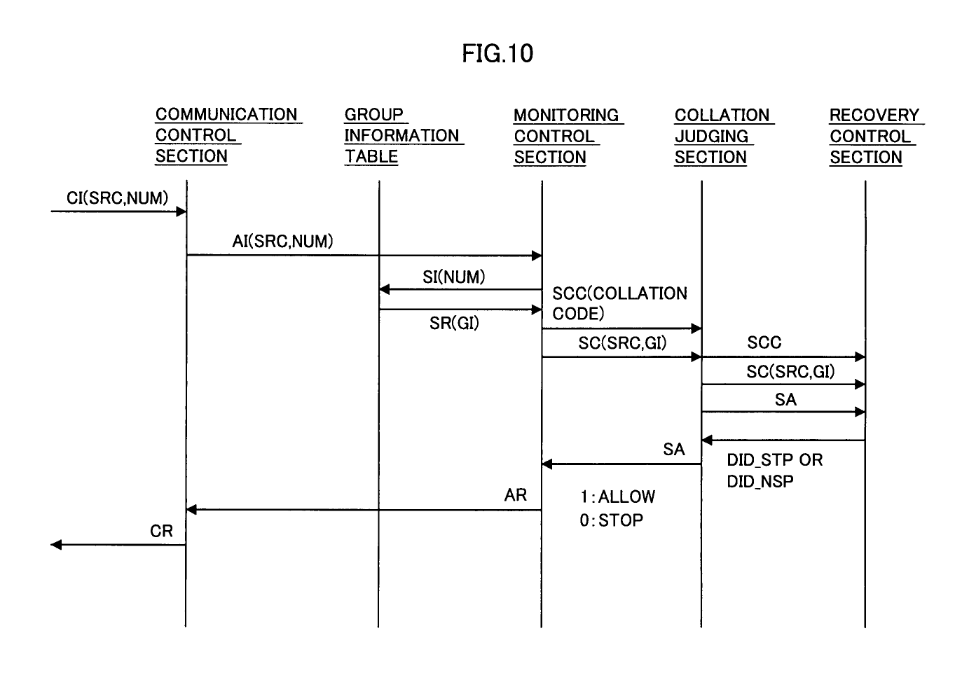

Next, the case when the control code SCC is the “collation code” will be explained by using FIG. 10. When a speech is requested from either one terminal (originator's terminal) in the same manner with the first embodiment, the originator information SC and the control code SCC are inputted to the collation judging section 205. Corresponding to that, the collation judging section 205 outputs the judgment result information SA corresponding to the control code SCC and the originator information SC to the monitoring control section 204 in the first embodiment as shown in the collation judging process in FIG. 9. However, the third embodiment is different from the case of the first embodiment in that the collation judging section 205 outputs the judgment result information SA to the recovery control section 206 prior to outputting it to the monitoring control section 204.

Accordingly, the three signals indicated by the originator information SC, the control code SCC and the judgment result information SA are inputted to the recovery control section 206 from the collation judging section 205. In this case, the control code SCC is the “collation code” and the originator information SC contains the originator's phone number SRC and the group identifier GI as described above. The judgment result information SA is a signal indicating whether or not a connection may be made as a result of collation like the first embodiment and may be a signal indicating 1 if the connection is to be allowed or 0 if the connection is to be stopped.

As a result of a collation judging process described later, the recovery control section 206 outputs the output signal DID_STP or DID_NSP corresponding to the input of the control code SCC, the originator information SC and the judgment result information SA described above. When the signal DID_STP is outputted, the collation judging section 205 outputs the judgment result information SA of stopping to the monitoring control section 204 whatever an output value of the judgment result information SA outputted once to the recovery control section 206 was and when the signal DID_NSP is outputted, the collation judging section 205 outputs the judgment result information SA of allowing a connection to the monitoring control section 204 whatever the output value of the judgment result information SA outputted once to the recovery control section 206 was. Thus, the judgment result of the collation judging section 205 is switched corresponding to the output of the recovery control section 206 in the present embodiment.

While it has been described above that the registration of the annoying phone call and the allowance and/or stop of the incoming are operated depending on the preferential instruction of the recovery control section 206 rather than the collation judging section 205, these are so arranged to realize the following operations by the update and collation codes. States how these operations are realized will be explained below by using FIG. 8.

### (Updating Process)

A purpose of the update code is to cause the operation for registering an annoying phone call for the first time only when a plurality of instructions to register the annoying phone call is generated without executing the registration of the annoying phone call hastily when only one user assumes an incoming from either one terminal as the annoying phone call among users using terminals contained in a group identified by the group identifier GI specified in advance for example.

For example, malicious naughty phone calls and persistent solicitation phone calls executed organizationally often come in bunches to a certain group or within a certain period of time. Meanwhile, a concept of “annoying phone call” varies depending on recipients of the phone call. For example, when a family member of someone within a group accidentally makes a phone call to that person's place of work, there may be a case when a director or a colleague of the place of work registers the call as an “annoying phone call” by mistake. If only one phone call is registered as an annoying phone call like this case, even means for making an emergency call between the family member and the user of the terminal belonging to that group might be disconnected after that. Therefore, the update code is arranged so as to cause the process for registering (updating) annoying phone call only when a number of times of instructions made by recipients of the phone calls to register annoying phone calls reaches to a certain number of times. The operation of the update code will be explained below by using FIG. 8.

In FIG. 8, the switch 22b is closed to the terminal b in an initial state. In the update code, the information outputted from the collation judging section 205 to the recovery control section 206 are the control code SCC and the originator information SC, which are inputted to the code judging section 22a and the switch 22b, respectively.

When the control code SCC is the update code, the code judging section 22a closes the switch 22b to the terminal a. Then, the originator information SC is inputted to the annoyance registration instructing number counter 24a through the switch 22b and the annoyance registration instructing number counter 24a counts a number of times when the annoying phone call registering process of the originator's phone number SRC is generated as “instruction for registering the annoying phone call” by correlating a group identified by the specific group identifier GI. Then, the annoyance registration instructing number counter 24a adds count information CNT to the originator's phone number SRC and outputs it as DID_CNTD to the instruction number of times judging section 24b. Accordingly, the DID_CNTD contains several information and becomes as DID_CNTD (SRC, GI, CNT) concretely. It is noted that the number of instructions for registering annoying phone call indicated by the annoyance registration instructing number counter 24a is one example of frequency of registrations indicating a degree requested to register an originator's terminal as an annoying terminal.

The instruction number of times judging section 24b judges the group identified by the predetermined group identifier GI whether or not the count information CNT meets a predetermined condition (criterion) described later and defined in advance. When the condition is met, the instruction number of times judging section 24b outputs a judgment signal LUP indicating “execute registration of annoying phone call” and the signal DID_CNTD to the time stamp applying section 26a.

The present embodiment is arranged so as to execute the registration process of the annoying phone call when 10% of terminals belonging to the group identified by the group identifier GI exercise the instruction to register the annoying phone call. Accordingly, when there exist a hundred of terminals belonging to the group identified by the group identifier GI, the originator's terminal is actually registered as the annoying phone call when users of 10 terminals operate the annoying phone call registration process or a user of one terminal operates the annoying phone call registration process repeatedly.

However, the criterion of the instruction number of times judging section 24b is not limited to that. It may be an absolute number or a method of executing the actual annoying phone call registration process corresponding to a certain numbers of users who want to register the annoying phone call calculated by using an arithmetic operation that starts by the instruction of registration. It is also possible to change the criterion per each group. For example, it will be readily understood that it is possible to attach weight to an important person and to weight one time of annoying phone call registration operation as that of two persons.

Returning again FIG. 8 to continue the explanation, the time stamp applying section 26a receives information concerning time from the time counter 26b and adds a time stamp TM to the inputted signal DID_CNTD and outputs it as a signal DID_CNT (SRC, GI, CNT, TM) to the recovery control signal outputting section 27.

When the recovery control signal output section 27 receives the signal DID_CNT from the time stamp applying section 26a, the recovery control signal output section 27 outputs the signal DID_STP to the collation judging section 205 and when the recovery control signal output section 27 receives no signal DID_CNT from the time stamp applying section 26a, the recovery control signal output section 27 outputs the signal DID_NSP to the collation judging section 205.

The collation judging section 205 does not perform the registration operation when it receives the signal DID_NSP. It is noted that the operation of the collation judging section 205 corresponding to the output of the recovery control signal output section 27 has been described above, so that an overlapped explanation thereof will be omitted here.

As described above, the third embodiment is arranged so that the registration operation is not carried out oversensitively by a very small number of instructions to register the annoying phone call within the group. Accordingly, it is possible to prevent an unmalicious wrong phone call or the phone call of the family member from being erroneously registered as an originator of annoying phone call. The phone number of the family member is essential in case of an emergency call, even though private calls may have to be refrained.

### (Collation Process)

Next, the collation process of the third embodiment will be explained by using FIGS. 7 and 8 again. When a speech is requested from either one terminal (originator's terminal), the collation judging section 205 generates the judgment result information SA that is a result of the collation process to indicate whether or not the phone call is an annoying phone call in the same manner with the first embodiment and outputs the judgment result information SA, the control code SCC and the originator information SC once to the recovery control section 206 as shown in FIG. 7.

The judgment result information SA outputted out of the collation judging section 205 is inputted to the refusal number of times counter 25a shown in FIG. 8 and the control code SCC is inputted to the code judging section 22a. The code judging section 22a judges whether or not a code is “collation code” from the control code SCC and closes the switch 22b to the terminal b when the code is the “collation code”. Because the originator information SC is inputted to the switch 22b from the collation judging section 205, the originator information SC is inputted to the refusal number of times counter 25a passing through the switch 22b. At this time, the annoyance registration instructing number counter 24a and the instruction number of times judging section 24b are needless.

The collation data DID_CNT (SRC, GI, CNT, TM) is being inputted to the refusal number of times counter 25a from the data storage section 29b. When the content of the judgment result information SA is “refuse” (e.g., 0), the refusal number of times counter 25a increments the count information CNT within DID_CNT by one. When the content of the judgment result information SA is “connect” (e.g., 1), the refusal number of times counter 25a does not increment the count of number of times of refusal. That is, what the refusal number of times counter 25a counts is a number of times of “phone calls made even though already registered as an annoying phone call”.

The refusal number of times counter 25a updates the count information of the originator information SC and outputs it as the signal DID_CNT to the refusal number of times judging section 25b. The time stamp TM will be described later. The refusal number of times counter 25a outputs the DID_CNT (SRC, GI, CNT, TM) to the refusal number of times judging section 25b. The refusal number of times judging section 25b compares the condition (e.g., 10% of the number of terminals belonging to a group) set in advance per each group identified by the group identifier GI and the count information CNT within the DID_CNT (SRC, GI, CNT, TM). It is noted that a value indicated by the count of number of times of refusal is one example indicating a degree of refusal of incoming of the originator's terminal.

When the number of terminals in the group identified by the group identifier GI is GIN, the refusal number of times judging section 25b outputs a signal CUP meaning that the originator's terminal made an annoying phone call again and the DID_CNT (SRC, GI, CNT, TM) containing the counted up count information CNT to the time stamp applying section 26a when a first condition represented by the following expression (1) is met. When the first condition represented by the following expression (1) is not met in contrary, the refusal number of times judging section 25b does not output the signal CUP:

First Condition: CNT≧GIN×0.1 (1)

When the signal CUP is inputted, the time stamp applying section 26a updates the time stamp TM to the signal DID_CNT (SRC, GI, CNT, TM) and outputs the signal DID_CNT (SRC, GI, CNT, TM) to the recovery control signal output section 27 as the signal DID_CNT (SRC, GI, CNT, TM). When the signal CUP is not inputted, the time stamp applying section 26a does not output the signal DID_CNT (SRC, GI, CNT, TM) to the recovery control signal output section 27.

When the signal DID_CNT (SRC, GI, CNT, TM) is inputted, the recovery control signal output section 27 outputs the signal DID_STP to the collation judging section 205 and no DID_CNT is inputted, outputs the signal DID_NSP. The operations of the collation judging section 205 when the respective signals are inputted have been described above, so that they will not be described here. The signal DID_CNT (SRC, GI, CNT, TM) is outputted to the number lock releasing section 29 described later.

In case of the collation code, the more the originator's terminal of the annoying phone makes phone calls, the more the value of the count information CNT (number of times of phone calls) increases and the first condition holds strongly as described above, so that the annoying phone call cannot be made to the specific terminal or group again.

Now, a mechanism for automatically releasing the registration of annoying phone, i.e., one of features of the third embodiment, will be explained next by using also FIG. 8. The automatic release of the registration of annoying phone is realized by operations of the number lock releasing section 29. The output information DID_CNT of the time stamp applying section 26a is inputted to the elapsed time calculating section 29a and the data storage section 29b. The data storage section 29b has a function of keeping the plurality of signals DID_CNT and is composed of a memory or a disk.

When the signal DID_CNT (SRC, GI, CNT, TM) is inputted from the time stamp applying section 26a, the elapsed time calculating section 29a reads the time stamp TM in the DID_CNT (SRC, GI, CNT, TM) and outputs a signal instructing to update the count information CNT and the time stamp TM linked with the originator's phone number SRC and the group identifier GI inputted this time to the data storage section 29b after a predetermined period of time from the time stamp TM.

For example, when a collation of an annoying phone call number x and a post y as the originator's phone number SRC and the group identifier GI occurs this time, the elapsed time calculating section 29a calculates an elapsed amount of time from the input of the time counter 26b and the time stamp TM of the signal DID_CNT (x, y, CNT, TM) and outputs a signal of updating information DID_CNT (x, y, CNT, TM) indicating information on records of the annoying phone call number x and the post y after one week for example to the data storage section 29b.

The data storage section 29b outputs the information DID_CNT (x, y, CNT, TM) to the count decrementing section 29c. The count decrementing section 29c counts down the count information CNT after one week for example as described above. Although the count decrementing section 29c is arranged so as to decrement the count information CNT by one (−1) in the present embodiment, the count decrementing section 29c is not limited to that number. It is noted that the value of the count information CNT of the information of the number of times of annoying phone call is one example of a value indicating a degree of annoyance of the originator's terminal.

The data storage section 29b outputs a signal DID_CNT (x, y, CNT′, TM) in which the count information CNT has been counted down to the time stamp applying section 26a. The time stamp applying section 26a appends a new time stamp TM′ to the signal DID_CNT (x, y, CNT′, TM) to make a signal DID_CNT (x, y, CNT′, TM′) and outputs it to the elapsed time calculating section 29a and the data storage section 29b as an updated new signal DID_CNT (x, y, CNT, TM). At this time, because no signal CUP meaning that the originator's terminal has made the annoying phone call again is inputted from the refusal number of times judging section 25b, the time stamp applying section 26a outputs nothing to the recovery control signal output section 27.

When no annoying phone call of the annoying phone call number x and the post y is thus made, the CNT information is decrementally updated per predetermined time (one week in the example described above) and the first condition represented by the aforementioned expression (1) becomes hard to hold. Then, the degree of annoyance of the annoying phone call number x becomes low and telephone calls can be made more easily. Then, the first condition (one exemplary predetermined condition) of the refusal number of times judging section 25b does not hold at the time when the value of the count information CNT does not meet the first condition any more, so that the signal DID_NSP is outputted to the collation judging section 205, allowing a speech. Although the present embodiment is arranged so as to erase the registration as the “data of originator of annoying phone call” from the data storage section 29b when the count information CNT becomes 0 (one example of a second condition), the second condition is not limited to that and the following expression may be used as the second condition for example:

Second Condition: CNT<GIN×0.1 (2)

As described above, according to the third embodiment of the invention, the recovery control section 206 is newly provided in addition to the function of the collation judging section 205 of the first embodiment. The recovery control section 206 is arranged so as to output a signal to the collation judging section 205 to execute the actual registration only when the instruction for registering annoying phone call occurs by a predetermined number of times or more in the update code and so as to increment the count information CNT of the information of number of times of annoying phone call only when the collation indicates that there exists the registration of annoying phone call and such that the more the count information CNT of the information of number of times of annoying phone call increases, the more hardly the phone call can be made again (i.e., the incomings are apt to be refused).

Then, the number lock releasing section 29 is provided within the recovery control section 206 to automatically erase information registered as “an annoying phone call originator's terminal” when no annoying phone call occurs for a certain period of time even if it is a terminal that has been registered as the annoying phone call terminal.

Thereby, even if a phone number registered as the annoying phone is assigned to a new unmalicious line subscriber by reassignment of the telephone number for example, its incoming is allowed as time elapses. That is, it is possible to avoid the shutout of incomings not caused by own responsibility, in addition to that the prevention of annoying phone calls may be realized by the first embodiment.

### Fourth Embodiment

Next, a fourth embodiment of the invention will be explained centering on differences from the first through third embodiments. Users themselves of recipient's terminals are unable to form a group to which the recipient's terminals belong in the first embodiment. That is, even when the users recognize phone calls of similar contents as annoying phone calls, they cannot be grouped on a side of the recipient's terminals. Accordingly, sharing of information on annoying phone call does not advance among the user terminals. Then, not only that a burden of the recipient's terminals continuing to register the annoying phone call number independently in accordance to the requests of the respective users occurs, but also the damage of the annoying phone call caused by the same originator's terminal spreads to the whole recipient's terminals.

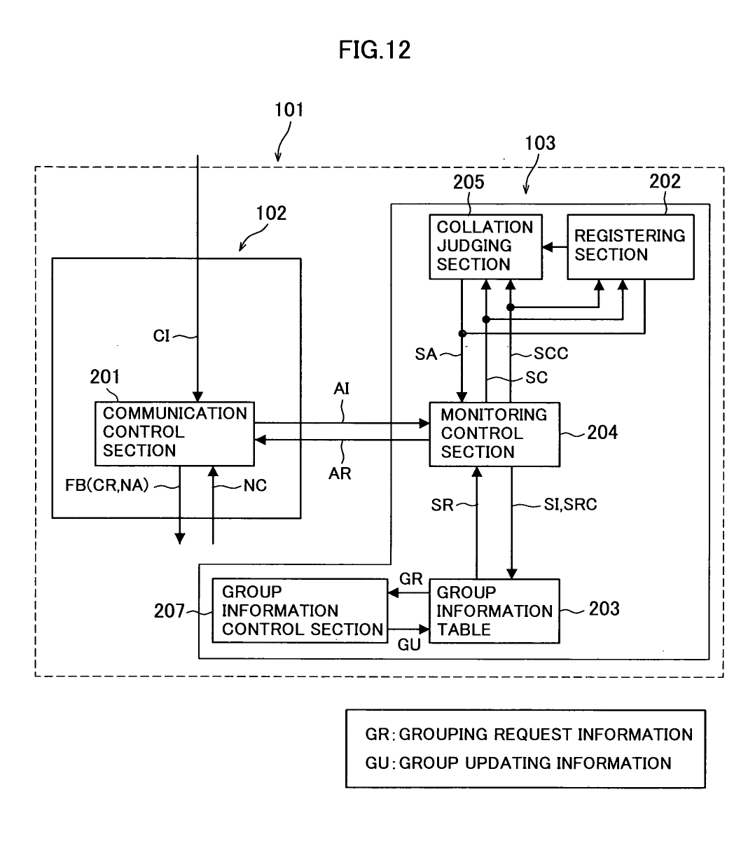

In addition, because an administrator of a telephone system is obliged to reconstruct the group every time when a new annoying phone is registered, it takes a lot of labor to administer the group. In view of such point, there is provided the telephone system 100 to which a function that enables each user terminal itself to form a group of telephone terminals (grouping) in accordance to an instruction of the terminal user. In order to realize this function, a group information control section 207 is added as shown in FIG. 12 and a method for constructing the group stored in the group information table 203 is differentiated. It is noted that although the respective functions of the first embodiment are applied in the present embodiment, the respective functions of the second embodiment may be also applied.

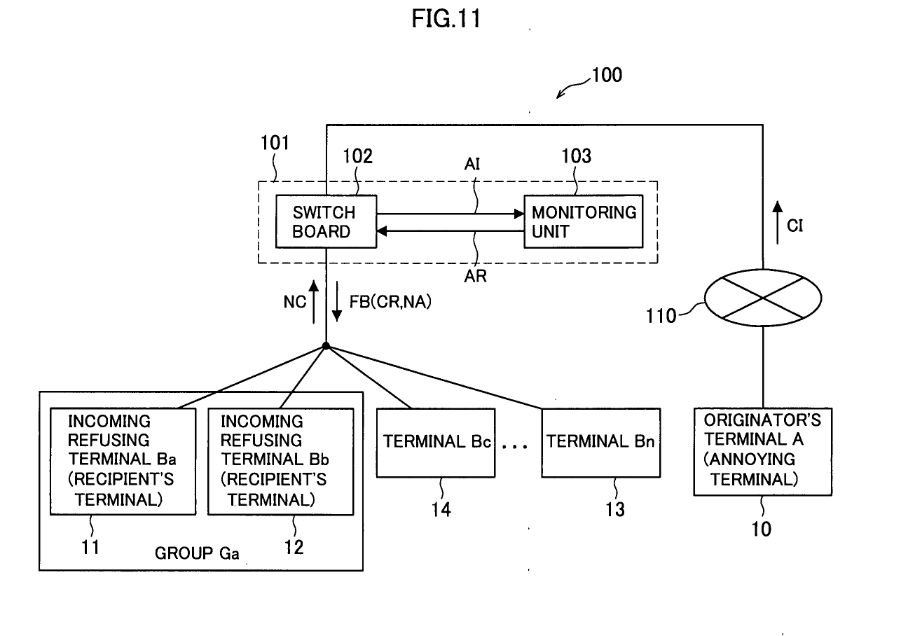

A structure of the present embodiment will be explained by using FIGS. 11 and 12. FIG. 11 is a schematic diagram showing the system structure of the fourth embodiment. As shown in FIG. 11, the telephone system 100 of the fourth embodiment has the network 110, the communication control unit 101 including the switching unit 102 and 103, the originator's terminal A 10, the recipient's terminals Ba 11, Bb 12, Bc 14, . . . and Bn 13.

It is noted that although the terminal A 10 is assumed to be the originator's terminal and the terminal Ba 11 and Bb 12 are assumed to be the recipient's terminals in the explanation of the present embodiment, every one of the terminals may have the functions of the originator's terminal and recipient's terminal in the practical operations. Furthermore, although the network 110 is a public telephone network, it may be another network such as IP network.

FIG. 12 is a functional structural view showing each function within the switching unit 102 and the monitoring unit 103 of the fourth embodiment by blocks. The switching unit 102 of the fourth embodiment has the communication control section 201. The monitoring unit 103 of the fourth embodiment also has the monitoring control section 204, the group information table 203, the collation judging section 205, the registering section 202 and the group information control section 207.

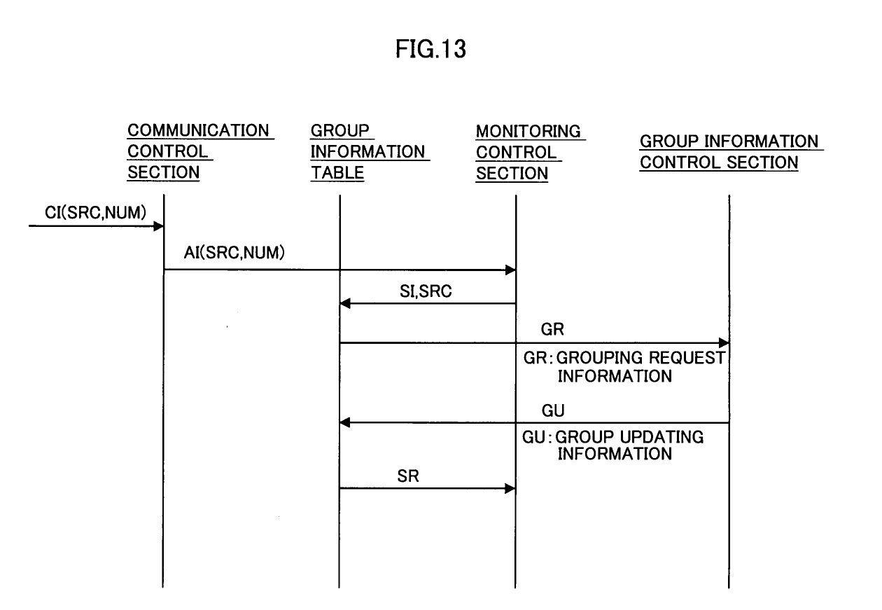

Next, operations of the present embodiment will be explained by using FIGS. 13, 14 and 15. One of the features of the present embodiment is to implement the construction of group in accordance to an instruction of the user of the recipient's terminal and the other functions are the same with the respective embodiments described above. For example, the operations of the switching unit 102 for obtaining the connection transmitting information CI and the incoming refusing code NC and the operations of the monitoring unit 103 for deciding whether incoming information from the annoying phone call number (originator's terminal) to the recipient's terminal should be allowed and the communication is to be connected or the incoming should be refused and the communication is to be disconnected are the same with those of the first embodiment. Accordingly, only the operations of the part relating to grouping in accordance to the instruction of the user of the recipient's terminal will be explained here and an explanation of other parts will be omitted here.

The explanation of the operations of the present embodiment will be made by exemplifying a case of forming a group in which the two terminals Ba 11 and Bb 12 determine the originator's terminal A 10 as an annoying telephone from a state in which no group exists. That is, the explanation of the operations will be made by supposing a state in which the recipient's terminal Bb 12 judges the originator's terminal A 10 as the annoying telephone and transmits the incoming refusing code NC to the switching unit 102 under a state in which the recipient's terminal Ba 11 has already registered the originator's terminal A 10 as the annoying telephone and in which the recipient's terminal Ba 11 and the recipient's terminal Bb 12 come to belong to the same group as a result.

It is noted that the present embodiment is not limited to the case in which there exists no group. It is also possible to register a recipient's terminal newly to an existing group and to further group existing groups.

The operation for grouping the recipient's terminals by the group information table 203 and the group information control section 207 will be explained below by using FIG. 13. At first, the recipient information SI and the originator's phone number SRC are registered in the group information table 203 from the recipient's terminal Bb 12 through the similar process with that of the first embodiment.

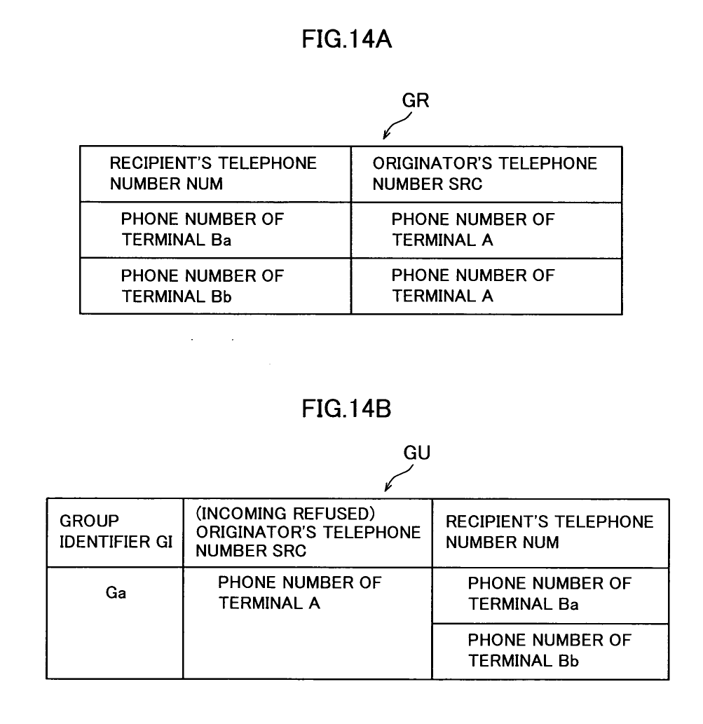

At this time, the group information control section 207 judges whether or not the originator's phone number SRC is what was registered in the past within the group information table 203. If the originator's phone number SRC is an originator phone number registered in the past, the group information table 203 outputs grouping requesting information GR to the group information control section 207 so that the group information control section 207 groups and stores the recipient's phone number (the phone number of the recipient's terminal Ba 11 here) and the phone number of the recipient's terminal Bb 12. It is noted that although FIG. 14A shows one exemplary structure of the grouping requesting information GR, the structure of the grouping requesting information GR is not limited to that.

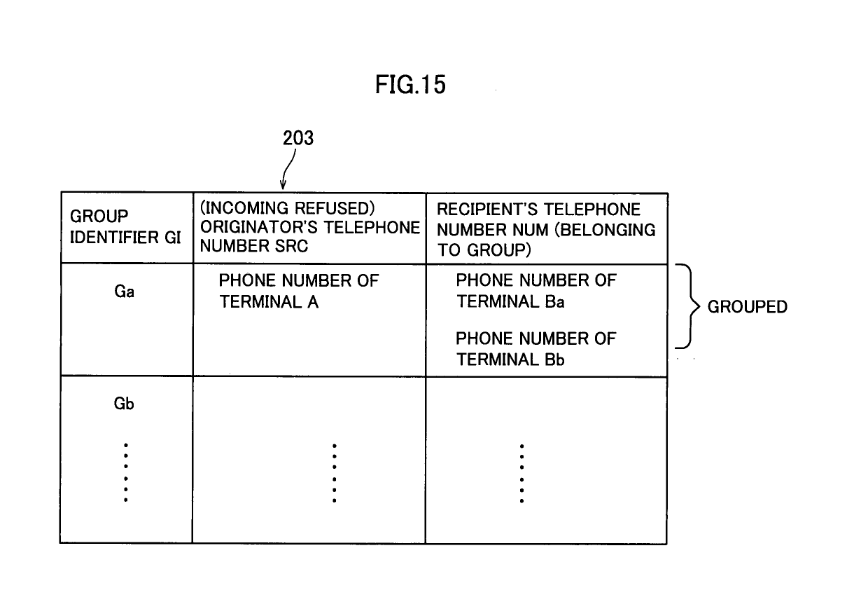

By receiving this grouping requesting information GR, the group information control section 207 generates a group identifier GI to be given to the recipient's phone number specified in the grouping requesting information GR, groups the recipient's terminal by using the group identifier GI and outputs it as group updating information GU to the group information table 203. It is noted that although FIG. 14B shows one exemplary structure of the group updating information GU and FIG. 15 shows one exemplary information stored in the group information table 203 corresponding to the group updating information GU in FIG. 14B, the structure of the group updating information GU and the storage method of the group information table 203 are not limited to them.

The recipient's terminals who sent the incoming refusing code NC to the same and one originator's phone number are grouped by the operations as described above in the present embodiment. It is noted that although the operations have been explained by exemplifying the case of grouping the individual recipient's terminals in the present embodiment, the grouping explained in the present embodiment is not limited to the case described above. That is, a new group may be formed by adding a recipient's terminal that has issued the incoming refusing code NC anew to a certain originator's phone number to an existing group that has judged the same originator's phone number as an originator's terminal of an annoying phone call.

It is also possible to form a new group by the same procedure by integrating the existing group that has judged that the specific originator's phone number as the originator's terminal of the annoying phone call with an existing group including the recipient's terminal that has issued the incoming refusing code NC anew to the same originator's phone number.

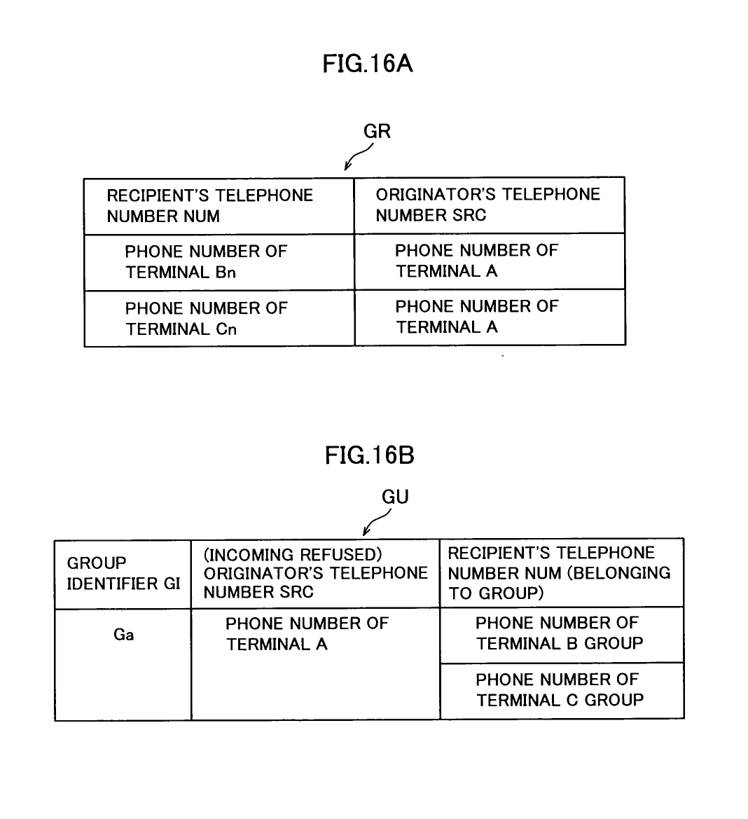

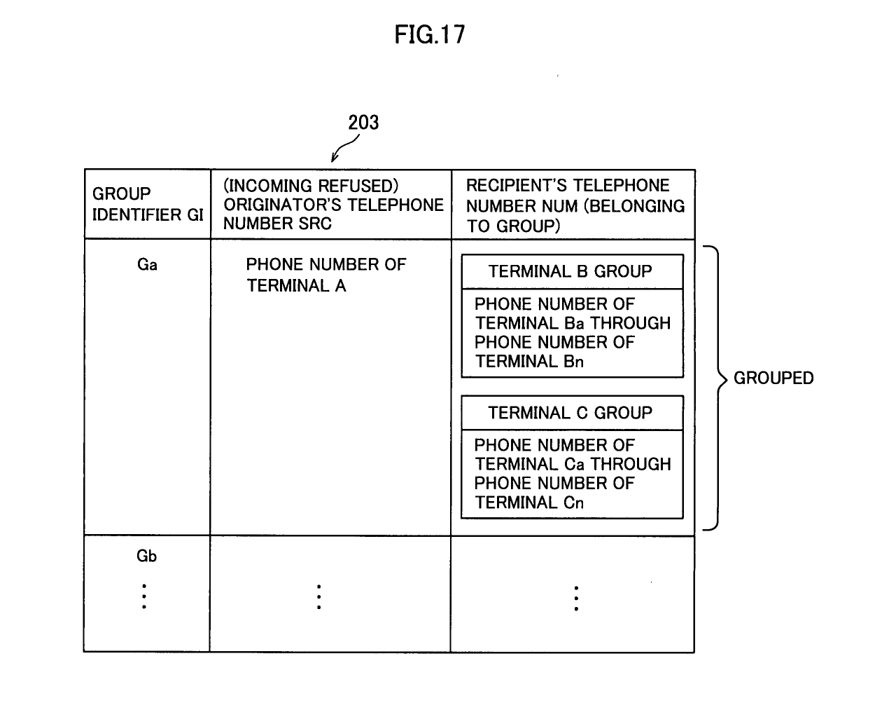

For example, when the grouping requesting information GR and the group updating information GU are generated as shown in FIGS. 16A and 16B, it is possible to group the groups of terminals B and terminals C by adding the existing group of terminals C including the recipient's terminal (e.g., the terminal Cn) that has issued the incoming refusing code NC anew to the same originator's phone number to the existing group of terminals B that has judged the phone number of the terminal A (originator's phone number) as the originator's terminal of the annoying phone call. FIG. 17 shows one example of information stored in the group information table 203 corresponding to the group updating information GU in FIG. 16B.

In addition, although the case of forming the group from the state having no group has been explained in the exemplary operations described above, it is of course possible to register in the existing group in the same manner even when one side of the groups described above is a sole terminal. That is, the group may be any types of group as long as it is a gathering of sole or a plurality of terminals.

In addition, although the grouping is carried out by providing the group information table 203 and by arranging the group information control section 207 so that it receives the grouping requesting information GR from the group information table 203 and outputs the group updating information GU to the group information table 203 in the present embodiment, the group information table 203 is one example of the storage section as described above and the storage section may be provided within the switching unit 102 or the monitoring unit 103 or may be solely provided outside.

Further more, the group of one or two or more recipient's terminals stored relative to identification information of a group already registered and the group of one or two or more recipient's terminals including the terminal newly requesting the refusal of incoming from the originator's terminal are stored in the group information table 203 relative to the identification information of the collated group.

When a number of terminals included in the group of terminals B is two or more or when a number of terminals included in the group of terminals C is two or more, there may be a terminal that has not directly requested the refusal of incoming among the terminals included in those groups. Accordingly, even though that terminal has not directly requested the refusal of incoming, there may be a case when the information from the specific originator's terminal does not come in linkage with the refusal of incoming issued by the other terminals within the group.

However, it is also conceivable that some terminals that have not directly requested the refusal of incoming want to obtain the information from the specific originator's terminal. Accordingly, it may be arranged so as to inquire of the terminal user not directly requesting the refusal of incoming among the grouped terminals about whether or not he and/or she wants to obtain the information from the specific originator's terminal and to refuse the incoming of the information transmitted from the specific originator's terminal when he and/or she does not want to obtain the information from the specific originator's terminal. When the user wants to obtain the information from the specific originator's terminal, it may be arranged to allow the incoming of the information regardless of that the user terminal belongs to the group refusing the incoming or to allow the user terminal to withdraw from the group refusing the incoming.

As described above, the group may be formed in accordance to the instruction of the user of the recipient's terminal by the present embodiment. Therefore, it becomes possible to widen a range of terminals sharing the information on the annoying originator's terminal and to form or reform the groups in a short time. It also enhances the effect of preventing annoying phone calls. In addition, because the group may be formed automatically, the administrator of the telephone system 100 can considerably save the labor required for administrating the group.

It is noted that the function of each section of the present embodiment may be realized by hardware or software. For example, the functions of the respective sections of the communication control unit 101 may be realized by arranging so that a CPU (not shown) executes a basic program for realizing the respective functions recorded in storage areas such as ROM and RAM (either of them are not shown).

In addition, although the telephone system using the public line network as the network has been explained in the present embodiment, the telephone system may be one using IP (Internet Protocol) network for example and the mechanism of the switching apparatus may be similar to a switching apparatus in a system using the IP network. In this case, the phone numbers indicated in the embodiments may be replaced with IP addresses for example. In addition, the respective embodiments may be carried out in combination and may be combined in any manner.

The switching unit 102 and a mail server 108 are one exemplary apparatuses for connecting or stopping communications among a plurality of terminals and the monitoring unit 103 controls if incoming information is to be refused or to be allowed.

The originator's phone number SRC is one exemplary identification information of the originator's terminal and the recipient's phone number NUM is one exemplary identification information of the recipient's terminal. These are not limited to be a phone number and may be information that allows identification of each terminal such as a mail address and an IP address. The group identifier GI is one example of identification information of a group and will do if it is information that allows identification of the group.

The storage areas provided in the group information table 203, the data storage section 29b of the recovery control section 206 and other sections are one exemplary storage section and the storage section may be provided within the switching unit 102 and the monitoring unit 103 or may be provided outside of the apparatus as described above.

More specifically, the identification information of one, or two or more recipient's terminals may be stored in the group information table 203 relative to the identification information of the group and the identification information of the originator's terminal may be stored in the storage area within the collation judging section 205 relative to the identification information of the group. In this case, the storage areas in the group information table 203 and within the collation judging section 205 function as the storage section. In addition, the identification information of one, two or more recipient's terminals and the identification information of the originator's terminal may be stored together in the group information table 203 relative to the identification information of the group as shown in FIG. 3. In this case, the group information table 203 functions as the storage section.

In addition, the plurality of terminals connected to the communication control unit 101 may be any type of apparatuses as long as they are electronic devices that can communicate by using the network 110 and can process information transmitted and/or received through the network such as PCs (Personal Computer), PDAs (Personal Digital Assistant: portable information terminal), cellar phones, devices of game machines and the like.

The operations of the respective sections are linked from each other in the embodiments described above and may be replaced as a series of operations by taking the linkages of the respective sections into consideration. Then, the embodiments of the invention of the communication control unit may be transformed into embodiments of a communication control method.

The communication control method may be also transformed into embodiments of a communication control program by replacing the operations of the respective sections with processes of the respective sections. In addition, the communication control program may be transformed into embodiments of a computer-readable recording medium recording the communication control program by storing the communication control program into the computer-readable recording medium. In this case, the communication control program executed by the computer may be stored in an arbitrary memory or may be taken in through the network 110.

While the preferred embodiments of the invention have been explained above with reference to the appended drawings, it is needless to say that the invention is not limited to those examples. It will be obvious that those skilled in the art may think of various changes and modifications within a scope of the invention described in the appended the claims and it is to be understood that those changes and modifications naturally belong to the technological range of the invention.

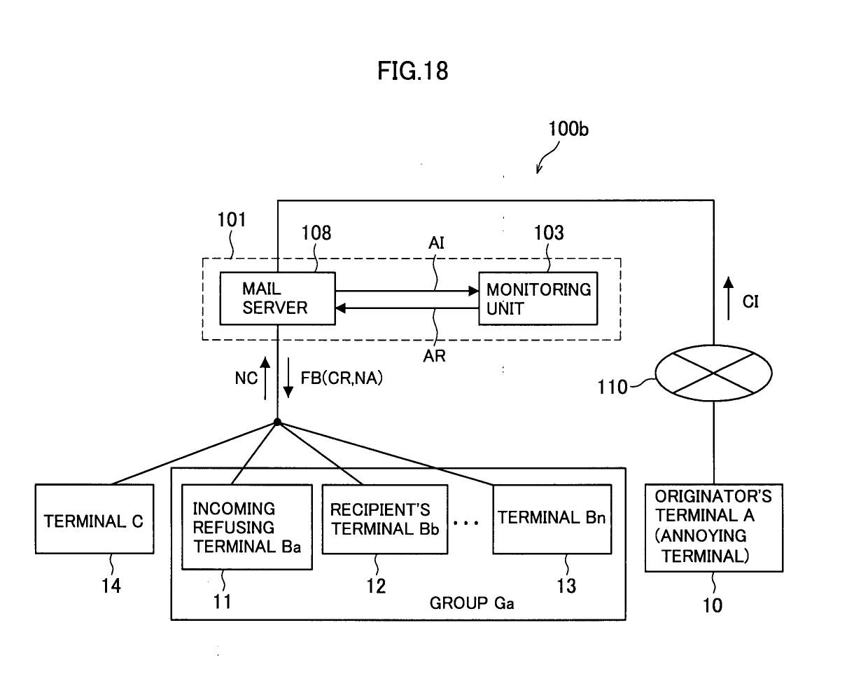

For example, the communication system of the invention is not limited to the telephone system 100 of the respective embodiments. That is, instead of the telephone system 100, the communication system may be a mail communication system 100b in which the mail server 108 is provided as shown in FIG. 18 in place of the switching unit 102 in FIG. 1 and that enables to transmit and/or receive mails from each other among a plurality of terminals based on a control made by the communication control unit 101 (i.e., the mail server 108 and the monitoring unit 103) and to refuse incoming mails of information transmitted from a terminal whose incoming mail is unwanted. That is, the telephone system 100 of the respective embodiments and the mail communication system 100b described above are one exemplary communication system of the invention in which the plurality of terminals and the communication control unit are connected through the network and that enables to transmit and/or receive information from each other among the plurality of terminals based on the control made by the communication control unit and to refuse the incoming information transmitted from the terminal whose incoming information is unwanted.

What is claimed is:

1. A communication system in which a plurality of terminals and a communication control unit enable to connect through a network, transmit and/or receive information each other among the plurality of terminals based on a control of the communication control unit, and refuse a receipt of information transmitted from an unwanted terminal; the communication control unit comprising:
a storage section for storing identification information of one or more recipient's terminals that belong to a group capable of refusing the receipt of the information transmitted from an arbitrary originator's terminal among the plurality of terminals relative to identification information of the group, and storing identification information of the originator's terminal relative to the identification information of the group;
a collation judging section for judging whether or not the originator's terminal is registered relative to the group to which a specified recipient's terminal belongs by collating the storage section, when either terminal that serves as the originator's terminal among the plurality of terminals requests to transmit information to the specified recipient's terminal; and
a communication control section for stopping a connection of communication between the originator's terminal and the specified recipient's terminal to refuse the receipt of the information transmitted from the originator's terminal to the specified recipient's terminal, when the originator's terminal is judged to be registered relative to the group to which the specified recipient's terminal belongs.

2. A communication control unit that enable to connect to a plurality of terminals through a network, transmit and/or receive information each other among the plurality of terminals, and refuse a receipt of information transmitted from an unwanted terminal, the communication control unit comprising:
a storage section for storing identification information of one or more recipient's terminals that belong to a group capable of refusing the receipt of the information transmitted from an arbitrary originator's terminal among the plurality of terminals relative to identification information of the group, and storing identification information of the originator's terminal relative to the identification information of the group; and
a collation judging section for judging whether or not the originator's terminal is registered relative to the group to which a specified recipient's terminal belongs by collating the storage section, when either terminal that serves as the originator's terminal among the plurality of terminals requests to transmit information to the specified recipient's terminal.

3. The communication control unit according to the the claim 2, further comprising:
a communication control section for stopping a connection of communication between the originator's terminal and the specified recipient's terminal to refuse the receipt of the information transmitted from the originator's terminal to the specified recipient's terminal, when the originator's terminal is judged to be registered relative to the group to which the specified recipient's terminal belongs.

4. The communication control unit according to the claim 2, further comprising:
a registering section for registering the identification information of the specified originator's terminal in the storage section relative to the identification information of the group to which the recipient's terminal that requests to refuse the receipt belongs among groups stored in the storage section, when either terminal that serves as the recipient's terminal among the plurality of terminals requests to refuse the receipt of the information transmitted from the unwanted originator's terminal.

5. The communication control unit according to the claim 2, wherein:
the communication control section connects the communication between the originator's terminal and the specified recipient's terminal to transmit the information from the originator's terminal to the specified recipient's terminal, when the collation judging section judges that the originator's terminal is not registered relative to the group to which the specified recipient's terminal belongs.

6. The communication control unit according to the claim 2, wherein:
the storage section stores a number of times of retrieval corresponding to the originator's terminal as an accumulated retrieval number relative to the originator's terminal, when the collation judging section retrieves whether or not the originator's terminal is registered in the storage section relative to the group to which the specified recipient's terminal belongs; and
the collation judging section judges whether or not to refuse the receipt of the information transmitted from the originator's terminal to the specified recipient's terminal in accordance to the accumulated retrieval number stored in the storage section, when the collation judging section judges that the originator's terminal is registered relative to the group to which the specified recipient's terminal belongs.

7. The communication control unit according to the claim 6, wherein:
the storage section stores frequency of refusal or allowance of the receipt among the number of times of retrieval indicated in the accumulated retrieval number stored relative to the originator's terminal; and
the collation judging section judges whether or not to refuse the receipt of the information transmitted from the originator's terminal to the specified recipient's terminal based on the frequency of the refusal or the allowance of the receipt among the number of times of retrieval corresponding to the originator's terminal stored in the storage section, when the collation judging section judges that the originator's terminal is registered relative to the group to which the specified recipient's terminal belongs.

8. The communication control unit according to the claim 2, wherein:
the storage section stores one or more groups to which one or more recipient's terminals belong; and
the collation judging section retrieves repeatedly whether or not the originator's terminal is registered respectively relative to one or more groups to which the specified recipient's terminal belongs by a number of the groups to which the specified recipient's terminal belongs, and judge whether or not to refuse the receipt of the information transmitted from the originator's terminal to the specified recipient's terminal based on a result of retrieval.

9. The communication control unit according to the claim 2, further comprising:
a recovery control section inputs the identification information of the originator's terminal and a control code outputted from the collation judging section, when the inputted control code is an update code requesting to change the content of the storage section, increments frequency of registrations indicating a degree requested to register the originator's terminal identified from the inputted identification information of the originator's terminal as an annoying terminal, and judges whether or not the frequency of registrations meets a predetermined condition; and
the collation judging section judge whether or not to refuse the receipt of the information transmitted from the originator's terminal to the specified recipient's terminal based on a result of judgment made by the recovery control section.

10. The communication control unit according to the claim 2, further comprising:
a recovery control section that inputs the identification information of the originator's terminal, a control code and judgment result information indicating a result of judgment made by the collation judging section, when the inputted control code is a collation code requesting to judge whether or not the originator's terminal is an incoming refusing terminal, increments a degree of a refusal receipt of the originator's terminal stored in the storage section relative to the inputted identification information of the originator's terminal corresponding the judgment result information, and judges whether or not the degree of the refusal receipt meets a predetermined condition; and
the collation judging section judge whether or not to refuse the receipt of the information transmitted from the originator's terminal to the specified recipient's terminal based on a result of judgment by the recovery control section.

11. The communication control unit according to the claim 9, wherein:
the recovery control section judges that the frequency of registration meets the predetermined condition, when a value of counter indicating the frequency of registration exceeds a predetermined count number as the predetermined condition.

12. The communication control unit according to the claim 10, wherein:
the recovery control section judges that the degree of refusal of the receipt meets the predetermined condition, when a value of counter indicating the degree of the refusal receipt exceeds a predetermined count number as the predetermined condition.

13. The communication control unit according to the claim 11, wherein:
the predetermined count number used as the predetermined condition is represented by an arbitral ratio to a number of recipient's terminals stored relative to the group of the group identification information stored in the storage section.

14. The communication control unit according to the claim 9, wherein:
the recovery control section decreases a degree of annoyance of the originator's terminal when a period of time becomes longer during which the originator's terminal identified by the identification information of the originator's terminal stored in the storage section does not request to transmit the information to the recipient's terminal belonging to the group stored relative to the originator's terminal, judges whether or not to release the refusal of the receipt of the recipient's terminal belonging to the group stored in the storage section relative to the originator's terminal by judging whether or not the degree of the annoyance of the originator's terminal meets a predetermined first condition.

15. The communication control unit according to the claim 14, wherein:
the recovery control section judges whether or not to erase the registration of the originator's terminal corresponding to the degree of the annoyance stored in the storage section by judging whether or not the degree of the annoyance of the originator's terminal meets a second predetermined condition.

16. The communication control unit according to the claim 14, wherein:
the recovery control section judges that the refusal of the receipt of the recipient's terminal that belongs to the group stored relative to the originator's terminal is released, when the counter value indicating the degree of the annoyance of the originator's terminal is equal to or less than the predetermined count number as the first condition.

17. The communication control unit according to the claim 16, wherein:
the predetermined count number used as the first condition is represented by an arbitral ratio to a number of recipient's terminals stored relative to the group of the group identification information stored in the storage section.

18. The communication control unit according to the claim 15, wherein:
the predetermined count number used as the second condition is smaller than the predetermined count number used as the first condition.

19. The communication control unit according to the claim 9, wherein:
the communication control section decides to stop or connect the communication between the originator's terminal and the specified recipient's terminal based on the judgment result information by the recovery control section regardless of the judgment result information by the collation judging section.

20. The communication control unit according to the claim 2, wherein:
when an arbitrary originator's terminal is registered in the storage section corresponding to a terminal newly requesting the refusal of the receipt of the originator's terminal, if the identification information of the originator's terminal has been already registered relative to identification information of either group, the storage section stores one or more groups of the recipient's terminals stored relative to the identification information of the group that has been already registered in relation to one or more groups of recipient's terminals including the terminal newly requesting the refusal of the receipt of the originator's terminal relative to the identification information of the group already registered.

21. The communication control unit according to the claim 2, including:
an apparatus for connecting or stopping the communication among the plurality of terminals; and
a monitoring unit for monitoring the apparatus, wherein:
the apparatus has the communication control section;
the monitoring unit has the collation judging section, the registering section and a monitoring control section; and
judgment result information judged by the collation judging section is transmitted to the communication control section via the monitoring control section.

22. A communication control method that enable to connect to a plurality of terminals through a network, transmit and/or receive information each other among the plurality of terminals based on a control of the communication control unit, and refuse a receipt of information transmitted from an unwanted terminal; the communication control method comprising steps of:
storing identification information of one or more recipient's terminals that belong to a group capable of refusing the receipt of the information transmitted from an arbitrary originator's terminal among the plurality of terminals relative to identification information of the group in a storage section, and storing identification information of the originator's terminal relative to the identification information of the group in the storage section;
judging whether or not the originator's terminal is registered relative to the group to which a specified recipient's terminal belongs by collating the storage section, when either terminal that serves as the originator's terminal among the plurality of terminals requests to transmit information to the specified recipient's terminal; and
stopping a connection of communication between the originator's terminal and the specified recipient's terminal to refuse the receipt of the information transmitted from the originator's terminal to the specified recipient's terminal, when the originator's terminal is judged to be registered relative to the group to which the specified recipient's terminal belongs.

23. A communication control program for executing by computer processes of transmitting and/or receiving information among a plurality of terminals that enable to connect through a network, and processes of refusing a receipt of information transmitted from an unwanted terminal; the communication control program comprising processes of:
storing identification information of one or more recipient's terminals that belong to a group capable of refusing the receipt of the information transmitted from an arbitrary originator's terminal among the plurality of terminals relative to identification information of the group in a storage section, and storing identification information of the originator's terminal relative to the identification information of the group in the storage section;
judging whether or not the originator's terminal is registered relative to the group to which a specified recipient's terminal belongs by collating the storage section, when either terminal that serves as the originator's terminal among the plurality of terminals requests to transmit information to the specified recipient's terminal; and
stopping a connection of communication between the originator's terminal and the specified recipient's terminal to refuse the receipt of the information transmitted from the originator's terminal to the specified recipient's terminal, when the originator's terminal is judged to be registered relative to the group to which the specified recipient's terminal belongs.

24. A monitoring unit for monitoring an apparatus that connects or stops a communication between a plurality of terminals; the monitoring unit comprising:
a storage section for storing identification information of one or more recipient's terminals that belong to a group capable of refusing the receipt of the information transmitted from an arbitrary originator's terminal among the plurality of terminals relative to identification information of the group, and storing identification information of the originator's terminal relative to the identification information of the group;
a collation judging section for judging whether or not the originator's terminal is registered relative to the group to which a specified recipient's terminal belongs by collating the storage section, when either terminal that serves as the originator's terminal among the plurality of terminals requests to transmit information to the specified recipient's terminal; and
a monitoring control section for instructing the apparatus to stop a connection of communication between the originator's terminal and the specified recipient's terminal, when the originator's terminal is judged to be registered relative to the group to which the specified recipient's terminal belongs.
